(19) United States
(12) Patent Application Publication
(10) Pub. No.: US 2002/0123951 A1
(43) Pub. Date: Sep. 5, 2002

(54) System and method for portfolio allocation

(76) Inventors: Richard B. Olsen, Zurich (CH); Thomas Domenig, Zurich (CH); Rakhal D. Dave, Zurich (CH)

Correspondence Address: PENNIE & EDMONDS LLP, 1667 K STREET NW, SUITE 1000, WASHINGTON, DC, 20006

(21) Appl. No.: 09/978,791

(22) Filed: Oct. 18, 2001

Related U.S. Application Data
(60) Provisional application No. 60/240,964, filed on Oct. 18, 2000.

(51) Int. Cl. G06F 17/60

(52) U.S. Cl. 705/36

(57) ABSTRACT

The Portfolio Allocation System of the present invention is a comprehensive tool which accepts user specified scenarios describing selected aspects of future price evolution—and provides as output an efficient frontier for portfolio re-allocation—taking into account transaction costs and costs of carry (the cost associated with foregoing the risk free interest rate where applicable). The product uses intensive monte-carlo computations and is supported by a network of machines. Users can interact with the system over the internet or through modem—using a specially developed user interface.

### 1 RELATED APPLICATIONS

This application claims priority to provisional application No. 60/240,964 filed on Oct. 18, 2000, titled, “A System and Method for Portfolio Allocation”, the contents of which are herein incorporated by reference.

### 2 FIELD OF THE INVENTION

If The present invention relates to a method and system for portfolio allocation. More specifically, the present invention determines a portfolio from past values of underlyings and from views about the future values of the underlyings.

### 3 BACKGROUND OF THE INVENTION

A portfolio is a specification of the number of units of an asset held from a universe of assets. The portfolio allocation problem requires the determination of an optimal portfolio of the specification of the number of units of each asset in the universe of assets. There exists a need for a system and method for portfolio allocation that determines a portfolio from views about future values of underlyings. There exists a further need for a method of interacting with a computer to determine a portfolio from forecasts defined by a user.

### 4 SUMMARY OF THE INVENTION

The present invention determines a portfolio from past values of underlyings and from views about the future values of underlyings. One aspect of the present invention is a method for determining a portfolio comprising the steps of: inputting past portions of one or more time series of one or more underlyings; inputting one or more views about the future of the one or more time series; and determining one or more future paths of the one or more time series from the past portions and said views.

Another aspect of the present invention is a method for interacting with a computer to determine a portfolio comprising the steps of: executing an application comprising at least one input command to select one or more assets for the portfolio and to define one or more forecasts, and at least one output command to display one or more results; issuing said at least one input command to cause the application to display at least one configuration window having a plurality of input controls; manipulating said input controls in said configuration window to select one or more assets for the portfolio and to define one or more forecasts; and issuing said at least one output command to cause the application to produce and display one or more results.

### 5 BRIEF DESCRIPTION OF THE FIGURES

FIG. 1 illustrates the computational parts of the portfolio allocation system of the present invention as well as the relationship among them.

FIG. 2 illustrates the processing of an ensemble of synthetic future paths associated with each of the input time series.

FIG. 3 illustrates a 3-dimensional subspace Rⁿ used to explain the correlation scenarios.

### 6 DETAILED DESCRIPTION OF THE PREFERRED EMBODIMENT

6.1 OPAS Mathematical Specification

6.1.1 Introduction

Portfolio and Assets We define a portfolio as a specification of the number of units of an asset held from a universe of assets A. Each asset represents a single item that may be traded independently from other assets within the scope of institutional constraints. Portfolio Allocation The portfolio allocation problem is a multivariate optimization problem which requires the determination of an optimal portfolio (the exact specification of the number of units of each asset in the universe of assets) that maximizes returns for a prescribed risk level. The risk level is usually measured in terms of the value at risk in the profit and loss currency at a defined confidence level. Both the risk level and the profit associated with the optimized portfolio are determined on the basis of a knowledge base that includes:

1. the underlying time series using which the assets are valued,

2. stochastic volatility models which try to predict future evolutions of the underlying time series and

3. user scenarios which may relate to views about time series evolution—in which case we call them dynamic scenarios—and/or

4. views about the probability of the series evolving to various levels in the future—in which case we call them static scenarios.

The portfolio re-allocation problem is different from the portfolio allocation problem only with regard to the penalty in the profit that is to be paid in transaction costs which must be included in the optimization problem.

Underlying Time Series In this document we avoid the usage of the term underlying asset and simply refer to underlying time series. This is partly to avoid any conflict with the usage of the word asset which we reserve for the actual items held in the portfolio but also partly because it is not true in general that every underlying time series is directly connected to some single simple asset which it values. (For example—we may choose to make the mean level, slope or curvature of the yield curve as the underlying time series—although this series alone cannot allow the reconstruction of a single point on the curve.) The underlying time series must satisfy two conditions:

1. The time series should not have a known exact dependency on other underlying time series.

2. If a maturity is associated with the time series, this maturity must always be relative to the present time point and not an absolute point in time.

Quite often, the underlying time series is closely related to the value of a single simple asset —but even so—we shall strongly avoid regarding this series as anything more that a set of numbers that define the financial climate. In these latter cases we shall still regard the corresponding single simple asset as determined from the series via an asset valuation function which may well be the identity operation—and in this sense all assets are derivatives of the underlying time series.

Asset Valuation, Strategies and Hedging The proposed portfolio allocation system makes no assumption about the linearity of assets with respect to the underlying time series. One of the salient features of this system is its ability to handle not only assets but strategies which are prescribed rules for entering and neutralizing positions in one or more assets (for example trading models or rules of roll-over). The system offers optimization of strategies conditional to the knowledge base described in the Portfolio Allocation section. The system can include the optimal strategy as an additional asset and determine the optimal investment in the strategy in the portfolio context. Dynamic hedging with trading models is an automatic consequence of the system—since the portfolio can have a position in the US Dollar and a trading model against the US Dollar as two separate assets with different weights in the portfolio.

Simulation Model One embodiment of the present invention solves the portfolio re-allocation problem via monte-carlo simulation, which involves the construction of multivariate correlated paths into the future for each underlying time series. The generating function or simulation model for these paths is the function of the underlying time series history which provides the covariance matrix and mean vector associated with a Gaussian distribution function from which the next days value for the underlying time series may be inferred. Every underlying time series is updated by picking a random vector from this distribution and appending the underlying time series with the corresponding elements (with appropriate transformation as necessary) to construct a new history. The generating function can then act on the updated history and the process of generating covariance matrix and appending path may be continued until any point desired in the future. A single multivariate simulation is anecdotal and without any forecasting significance—but a large ensemble of these multivariate paths will provide a forecast within a probabilistic framework.

6.1.2 System Parts

Definitions The following definitions are organized to systematically introduce various mathematical objects. It is necessary to define these object to understand the system parts at the broadest level. The reader is advised to make one reading of the definition in the order of their appearance but return to them later since they may become clear only in their structural and mathematical context:

Time—t: The time t defines a specific business days. t=0 represents today (or the nearest past business day if today is a holiday or todays data is not yet collected). Negative t represents the number of business days in the past before today and positive t represents number of business days in the future after today.

P/L Currency: This is the currency in which VaR and Return for the portfolio are measured.

Universe of Assets—A: This is the universal set of assets which a portfolio may exploit for investment.

Number of Assets—N_{A}=#(A)

Portfolio Phase Space—P: The space defining the number of units of each element in A is the unconstrained phase space available for portfolio allocation. P includes in its definition any further institutional investment constraints imposed on this phase space. The current portfolio is a single point in P.

Specific Asset—k, l: These are labels for the specific assets supported in A. Wherever you see a variable with letter k as a superscript or subscript it refers to the specific asset labeled by k. Occasionally we will need two labels and in this case we shall use i, l ε A.

Asset Return—aₜ^{k}: The real number representing the return of asset k in the P/L currency at time t for a unit holding of invested at time t=0 (now). a^{k} (without subscript t) refers to the series and not a specific value.

Underlying Set—U: This is a set of underlying time series of daily data labels. An underlying time series consists of a sequence of values which are used to value assets on a day to day basis until the last day in the time series.

Number of Underlying Series—Nᵤ=#(U)

Specific Underlying—i, j: These are labels for the specific underlying time series in set U. Wherever you see a variable with letter i as a superscript or subscript it refers to a specific underlying time series. Occasionally we will need two labels and in this case we shall use i, j ε U

Asset Dependency Subset—Uₖ: Associated with each k ε A is Uₖ ⊂U which specifies what underlying time series labels i the asset k depends on. It should be clear from the foregoing definitions that it is sufficient to define U=∩_{kεA}Uₖ.

Dimension—nₖ: Associated with each k ε A is nₖ=#(Uₖ) which is the number of elements in Uₖ and hence the number of time series on which the value of asset k depends.

Underlying Data—uₜⁱ: The real number associated with the underlying historical data time series i ε U, for a specific day t. uⁱ (without subscript t) refers to the series and not a specific value.

Asset Return Function—Aₖ: This is a function which acts on the nₖ time series i ε Uₖ⊂ U so that a_{τ}^{k}=Aₖ(Uₜⁱ,∀i ε Uₖ, ∀t≦τ) (see definition of Asset Return a_{τ}^{k} for precision). The asset return function is the area where we expect external resources to be useful. Allfonds is clearly one important candidate for providing a library of functions for several classes of assets k.

Variance Model—Mⁱ: It is assumed that for each series uⁱ there exists a univariate model Mⁱ which takes as input, the data uₜ ⁱ for all t≦τ and produces as output, the variance s_{τ}ⁱⁱ describing the Gaussian distribution from which the logarithmic price change x_{τ+1}ⁱ=log(u_{τ+1}ⁱ/u_{τ}ⁱ) must come.

Covariance Model—M^{ij}: It is assumed that for each series uⁱ and u^{j} there exists a bivariate model M^{ij} which takes as input, the data uₜⁱand uₜ^{j} for all t≦τ and produces as output, the covariance s_{τ}^{ij} describing the bivariate Gaussian distribution from which the logarithmic price change vector (X_{τ+1}ⁱ,X_{τ+1}^{j})=(log(u_{τ+1}ⁱ/u_{τ}ⁱ), log(u_{τ+1}ⁱ/u_{τ}ⁱ)) must come.

Scenario Set—Uₛ: Uₛ ⊂U identifies the underlying time series for which the user has some view about the distribution at some horizon θᵢ.

Number of Underlyings in Scenario Set—N_{U}_{ₛ}=#Uₛ

Scenario Horizons—θᵢ: For each i ε Uₛ the user configures t=θᵢ <100 as a future point in time where the user has a definite view of the distribution of uₜⁱ. It is important before the simulation starts to know only the times θᵢ for which a scenario will be specified (the times may be different for each i ε Uₛ). The actual scenario specification will only be requested later.

Model Marginal Distribution—ρₘⁱ: This is the marginal distribution obtained for uₜⁱ at t=θᵢ for all i ε Uₛ, when the simulation is run without the constraint of reproducing distribution ρₛⁱ.

Random Vector and Variable—\vec{z}^{θ}and zᵢ^{θ}: We use this in mathematical expressions as the variable representing the value of the underlying i at t=θᵢ in the future. It is expressed in the same unit as uₜⁱ. We refrain from using u_{θ}ⁱ here and take the view that u_{θ}ⁱ is the actual value on the axis defined by variable zᵢ^{θ}. In expressions where i is implicitly clear we may simply use z^{θ}and we shall use \vec{z}⁷⁴ to refer to the vector with components zᵢ^{θ}.

Scenario Specification—ρₛⁱ: This is the marginal distribution of uₜⁱ at t=θᵢ which establishes the belief of the user. The simulation for each asset is constrained to reproduce ρₛⁱ. The user may decide to provide only one or more quantile or just the expected mean instead of a complete distribution. In general ρₛⁱ may be specified in 2 ways:

1. As a continuous distribution fully specified by the user and with no relation to ρₘⁱ.

2. As a transformation of ρₘⁱ using some prescribed methodology and some user inputs. For example, the user may only specify the expected mean mⁱ at θᵢ and we set ρₛⁱ(z_{θ})=ρₘⁱ(Z_{θ}−mⁱ). Other more complex transformations which would determine ρₛⁱ based on some criteria which claim to make the smallest change to ρₘⁱ in order to meet user constraints on ρₛⁱ (such as mean or quantile specifications) may also be available.

Portfolio Re-allocation Horizon—Δ: This is the customer prescribed horizon which determines the frequency at which the portfolio is to be reassessed. The default value for this horizon is 10 business days.

Expectation Vector of Asset Returns—μₜ^{A}: One output of the simulation system is the vector of mean asset returns (as expected by the knowledge base defined in Portfolio Allocation section) in the P/L currency at the portfolio re-allocation horizon for each asset k ε A: μ_{Δ}^{A}. This will be used by the portfolio allocation system to evaluate the mean profit expectation for a portfolio over the horizon Δ.

Covariance Matrix of Asset Returns—Σₜ^{A}: Another output of the simulation system is the covariance matrix of asset returns (as expected by the knowledge base defined in the Portfolio Allocation section). (see definition of a_{Δ}^{k}) in the P/L currency at the portfolio re-allocation horizon: Σ_{Δ}^{A}. This will be used by the portfolio allocation system to evaluate the VaR of the portfolio at prescribed confidence level over the portfolio re-allocation horizon. The system will also produce Σ_{1 Day}^{A}—to estimate the 1 day VaR of the portfolio. In the long run we may support the construction of Σₜ^{A}∀t ε [1 . . . Δ].

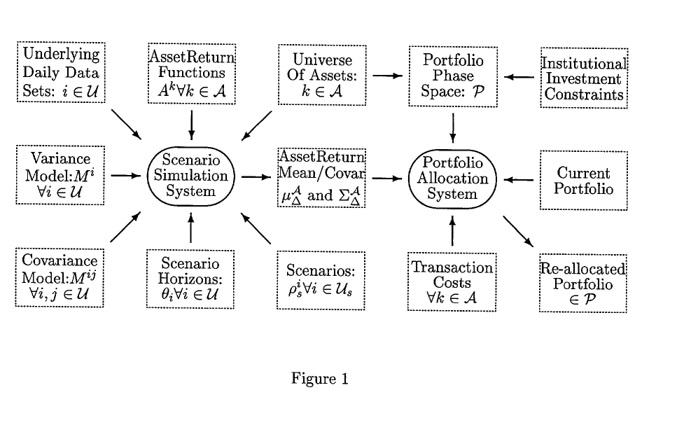

Description FIG. 1 illustrates the computational parts of the portfolio allocation system of the present invention as well as the relationship among them. These ampotational parts include:

1. Scenario Simulation System: This produces as output the covariance matrix Σ_{Δ}^{A} of asset returns (in the P/L currency) for the universe of assets associated with a portfolio—taking account user scenarios.

2. Portfolio Allocation System: This provides the portfolio re-allocation recommendations based on Σ^{A}.

The computational parts of the portfolio allocation system are represented by ovals. The data flows into the Scenario Simulation System along with various configured information and the library of Asset Return Functions to produce Σ_{Δ}^{A}. The Portfolio Allocation System takes as input μ_{Δ}^{A} and Σ_{δ}^{A} and various other input as specified to provide the recommended re-allocated portfolio. The Univers of Assets A and the Portfolio Re-allocation Horizon Δ (not shown explicitly due to lack of space) is the only common information shared between the two systems.

6.1.3 Outline

This section discusses the mathematical specification of the Scenario Simulation System and the Portfolio Allocation System, which uses μ_{Δ}^{A} and Σ_{Δ}^{A} as input. The system uses the Portfolio Allocation Tool (PAT).

While much of this section describes the main problem—the methodology of re-weighting paths to satisfy user scenarios—the portfolio allocation system of the present invention also involves the following issues.

An outline of the iterative process for simulation generation is as follows:

1. Apply stochastic models to construct covariance matrix Sₜ for describing the multivariate price evolution (at t+1) of the underlying time series ∀i ε U.

2. Use Choleski decomposition to construct a random realization from the distribution associated with Sₜ.

3. Append this random realization as the t+1 update to the underlying time series.

4. Then proceed to construct covariance matrix Sₜ₊₁, using the updated history.

The tweak functionality imposed on the underlying stochastic models which allows the user to enter scenarios related to the dynamics of price evolution changes the underlying model in a prescribed manner. In one embodiment, the tweak is already included in the definition of Mⁱ and M^{ij}.

The methodology for incorporating scenarios regarding the Euro. This is an extension of the tweak functionality applied so that the ECU time series evolves into the Euro at a prescribed date.

The manner in which continuous distributions are approximated from ensembles.

The organization and storage of information from the simulation for the purpose of visualization.

The manner in which trading model, roll-over or other strategies may be constructed on top of the pre-defined universe of assets and seamlessly added to the universe of assets A.

6.1.4 Scenario Simulation System

Definitions The following definitions are organized to systematically introduce various mathematical objects. It is necessary to define these object to specify the operation of the Scenario Simulation System. The reader is advised to make one reading of the definition in the order of their appearance but return to them later since they may become clear only in their structural and mathematical context:

Simulation—S: A simulation, in the present context, is an ensemble of paths generated into the future, for a set of underlying time series according to some prescribed financial model. If the time evolution of different time series is not independent—this is referred to as a multivariate simulation.

Simulation Set—set(S): This is the set which identifies all the underlying time series involved in the simulation S. In one embodiment, set(S)=U.

Simulation Dimension—dim(S): This is the number of time series involved in the multivariate simulation. In one embodiment, dim(S)=N_{U}.

Simulation Model—M(S): This is the full prescription which defines exactly how the simulation must occur. In one embodiment, it is the exact specification of which models Mⁱ and M^{ij} are to be used for predicting the covariance matrix associated with each i,j ε set(S). This may be a critical concept from the software design point of view.

Simulation Population—n_{S}: This is the maximum number of paths generated in the simulation.

Simulation Stopping Criterion: In one embodiment, the calling program must be able to stop the simulation if certain criteria are met before n_{S}, paths have been generated. In another embodiment the system of the present invention has no use for this support.

Simulation Path Label—η: The ensemble of paths generated by the model are labeled by natural numbers η. It should be clear that η ε [1 . . . n_{S}].

Simulation Path—u^{iη}: The underlying time series uⁱ is the real history of underlying i and hence is defined only for t≦0. Each simulation path generates hypothetical values for underlying i into the future. It is therefore natural to extend the usage of the principal symbol U and construct series U^{i,η} with values Uₜ^{i,η} which are the hypothetical values for underlying i for t>0 and associated with Simulation Path label η.To associate U^{i,η} with a specific simulation we may use the terminology U^{i,η} (S).

Simulation Horizon Vector—hor(S): In general, this is a vector of dimension dim(S) where the ith slot horᵢ(S) refers to the target time in the future until which Uₜ^{i,η} is to be simulated. We deviate here from a simplistic view that a simulation proceeds for all i until the same point in time. The reason for this is that we can increase computational speed by reducing the dimension of the simulation as various target times horᵢ(S) are reached. This is a key concept which must be supported in the first design. In one embodiment, dim(S) is of dimension N_{U} and the simulation horizon ∀i ∉ U_{S} and ∀i ε {U_{S} : θᵢ<Δ} is always set to Δ.

Scenario Vector—\vec{U}_{θ}^{η}: This is a vector of dimension N_{U}_{_{S}} defined by (\vec{U}₇₄ ^{η})i =U_{θ}_{ᵢ}^{i,η} where implicitly i ε U_{S}. Note that the θᵢ are generally unequal.

Scenario Mean Vector—\vec{μ}^{θ}: This is a vector of dimension N_{U}_{_{S}}. The components are determined by:

$${μ}_{i}^{θ} = \frac{1}{{n}_{s}} {\sum }_{η = 1}^{{n}_{s}} {u}_{{θ}_{2}}^{i , η} \qquad ( 1 )$$

Scenario Covariance Matrix—Σ^{θ}: This is the covariance matrix of vectors \vec{U}_{θ}^{η} and hence is a square matrix of dimension N_{U}_{_{S}}. The elements of this matrix are evaluated as:

$${\sum }_{ij}^{θ} = \frac{1}{{n}_{s}} {\sum }_{η = 1}^{{n}_{s}} ( {μ}_{{θ}_{i}}^{i , η} - {μ}_{i}^{θ} ) ( {μ}_{{θ}_{j}}^{j , η} - {μ}_{j}^{θ} ) \qquad ( 2 )$$

Portfolio Horizon Vector—\vec{U}_{Δ}^{η}: This is a vector of dimension N_{U} defined by (\vec{U}_{Δ}^{η})i(S)=U_{Δ}^{i,η}(S) where implicitly i ε U. Note that unlike \vec{U}_{θ}^{η}, in this case all components refer to the same point in time: Δ.

Objective Our objective for the Scenario Simulation System is to construct μ_{Δ}^{A} which is the vector of expected asset returns and Σ_{Δ}^{A} which is the forecast covariance matrix of asset returns (in the P/L currency) for assets k ε A over the portfolio re-allocation horizon Δ. The diagonal elements of Σ_{Δ}^{A} are the variance forecasts for asset k and the off-diagonal elements are covariance forecasts for each pair of k ε A. As the name suggests, the system may account for the bias established by user input scenarios ρ_{S}ⁱ.

Simulation Module In one embodiment, the Simulation Module acts on a set of under-lying historical time series defined by set(S) and a set of dim(S) Variance models Mⁱ and dim(S)(dim(S)—1)/2 Covariance models M^{ij}. The objective of the Simulation Module is to produces n_{S} series U^{i,η}∀i ε set(S).

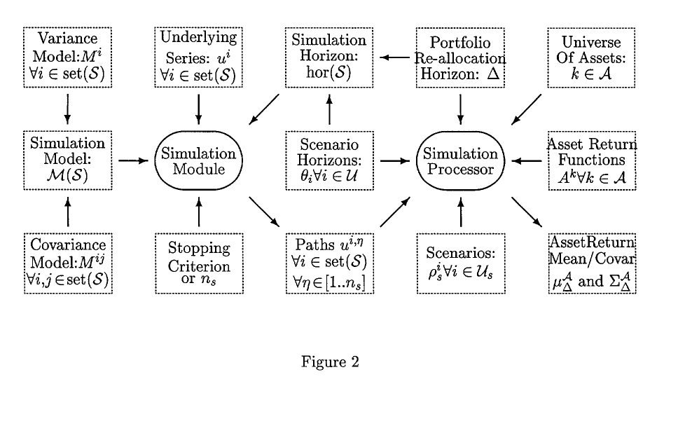

Simulation Processor FIG. 2 illustrates the processing of an ensemble of synthetic future paths associated with each of the input time series. The purpose of the Simulation Processor is to accept each path produced by the Simulation Module and act on it (see FIG. 2). This means that the Simulation Processor must be part of the loop that generates a new path. The following set of actions may be supported by the software:

1. Simulation Module produces new path and hands it over to Simulation Processor.

2. Simulation Processor decides what to do with the new path. It may decide to store some information for later use or take any other action as deemed by the author of the Simulation Processor.

3. After completing its actions, the Simulation Processor relinquishes control to the Simulation Module for creating a new path.

4. The above iteration continues until the simulation module hits its stopping condition.

5. Then the simulation module sends a done signal to the Simulation Processor.

6. The Simulation Processor may then continue working with information it has collected during the path generation process as required.

(FIG. 1-2 was here; the second figure of the first document)

6.1.5 Scenario Simulation Methodology

In one embodiment, the forecasts from the Scenario Simulation System are reconciled with user views of market evolution. The gist of the technology is to re-weight model paths using appropriately determined weights so as to reproduce user scenarios. Effectively the re-weighting of paths creates a new model—but with the claim that the original model has been disturbed by user scenarios least violently—in the following sense:

Univariate context: The approach of re-weighting conditional to path arrival at a specific point in the simulation phase space means that all paths arriving in the same neighbourhood are given the same weight. This implies that the relative probability of different paths passing through the same point in the phase space—as expected from the original model is conserved in the new model.

Multivariate context: Since the user may only specify marginal distributions, the methodology attempts to preserve the coupling of paths Uₜ^{i,η} between different i ε U (and possibly different t) for the same η. We define here coupling as the abstract mathematical object which defines the dependency and interrelation of paths associated with each underlying time series. The covariance and/or correlation are linear measures related to this abstract concept.

Univariate Example We first consider the re-weighting problem in the univariate context. Let the user have defined scenario ρ_{S}ⁱ associated with underlying i at time θᵢ. If the simulation is run and the model distribution ρₘⁱ is estimated then the weight of every path terminating in zᵢ^{θ}must be given the same weight:

$${ω}^{i} ( {z}_{i}^{θ} ) = \frac{{ρ}_{s}^{i} ( {z}_{i}^{θ} )}{{ρ}_{m}^{i} ( {z}_{i}^{θ} )} . \qquad ( 3 )$$

Bivariate Example We now consider the bivariate case to appreciate the re-weighting problem in the simplest multivariate context. It is tempting to simply generalize the multivariate problem from the univariate example and claim that

$${ω}^{ij} ( {z}_{i}^{θ} , {z}_{j}^{θ} ) = \frac{{ρ}_{s}^{i} ( {z}_{i}^{θ} ) {ρ}_{s}^{j} ( {z}_{j}^{θ} )}{{ρ}_{m}^{i} ( {z}_{i}^{θ} ) {ρ}_{m}^{j} ( {z}_{j}^{θ} )} . \qquad ( 4 )$$

This approach is entirely wrong because the denominator is not representative of the true distribution and so the re-weighting scheme will not even recover the marginals ρ_{S}ⁱ as required. Another approach is to compute weights:

$${ω}^{ij} ( {z}_{i}^{θ} , {z}_{j}^{θ} ) = \frac{{ρ}_{s}^{i} ( {z}_{i}^{θ} ) {ρ}_{s}^{j} ( {z}_{j}^{θ} )}{{ρ}_{m}^{ij} ( {z}_{i}^{θ} , {z}_{j}^{θ} )} . \qquad ( 5 )$$

Assuming that we can somehow reasonably estimate the bivariate distribution ρₘ^{ij} the approach is valid with regard to correctly re-weighting paths so that the marginal distributions ρ_{S}ⁱ will in fact be recovered in re-weighted ensemble. The approach is still however compromised by the fact that the numerator imposes a distribution for the ensemble which is independent and thus destroys the coupling of paths implicit in the model. This violates the principal of least violent disturbance to the model distribution ρₘ^{ij} and hence is unacceptable. In one embodiment, therefore we evaluate

$${ω}^{ij} ( {z}_{i}^{θ} , {z}_{j}^{θ} ) = \frac{{ρ}_{s}^{ij} ( {z}_{i}^{θ} , {z}_{j}^{θ} )}{{ρ}_{m}^{ij} ( {z}_{i}^{θ} , {z}_{j}^{θ} )} , \qquad ( 6 )$$

which is the correct weighting scheme which preserves the coupling implied by the simulation model and also correctly reproduces the scenarios ρ_{S}ⁱ specified by the user. The main challenge now is to estimate ρₘ^{ij} and also surmise ρ_{S}^{ij} such that ρ_{S}^{ij} preserves the coupling in ρₘ^{ij} in some sense.

One idea is to determine the correlation matrix of U_{θ}_{ᵢ}^{i,η}and U_{θ}_{ⱼ}^{j,η}and then claim that the distributions ρₘ^{ij} is the distribution which would recover the observed marginals ρₘⁱ and ρₘ^{j} and still preserve the observed correlation matrix. We could then apply the same technique on the user imposed marginals ρ_{S}ⁱ and ρ_{S}^{j} to construct ρ_{S}^{ij} and since both ρₘ^{ij} and ρ_{S}^{ij} have the same correlation matrix (explicitly by construction)—we satisfy the principal of least violent disturbance as required by the re-weighting procedure. This approach is however fraught with difficulty since no general method is available for constructing a bivariate (or in general multivariate) distribution which preserves a prescribed correlation matrix and reproduces prescribed marginals.

In one embodiment, therefore, we use the bivariate (and in general multivariate) Gaussian distribution of U_{θ}_{ᵢ}^{i,η} and U_{θ}_{ⱼ}^{j,η}—represented by ρ_{g}^{ij}—as an important intermediate element in the methodology since this is easily estimated from the simulation. We then use topological arguments and claim that the distribution ρₘ^{ij} is obtained from the distribution ρ_{g}^{ij} (zᵢ^{θ}, zⱼ^{θ}) by warping the zᵢ^{θ}and zⱼ^{θ}axes appropriately and independently so as to recover the estimated marginals ρₘⁱ and ρₘ^{j}. We then use the same procedure and construct distribution ρ_{S}^{ij} by again warping the zᵢ^{θ}and zⱼ^{θ}axes of ρ_{g}^{ij}(zᵢ^{θ}, zⱼ^{θ}) appropriately and independently so as to recover the user imposed marginals ρ_{S}ⁱ and ρ_{S}^{j}. Unlike the first idea (previous paragraph) where the correlation matrix as a measure of coupling was explicitly preserved between the distribution ρₘ^{ij} and ρ_{S}^{ij}, in this case the coupling is preserved in the topological sense—that both ρₘ^{ij} and ρₘ^{ij} are obtained from the same multivariate distribution ρ_{g}^{ij} by a warping function.

The above approach is mathematically tractable. It requires as input the distributions ρₘⁱ and ρ_{g}^{j} and the parameters μᵢ^{θ}and Σ^{θ} (defining the distribution ρ_{g}^{ij}) estimated from the simulation and also the scenario distributions ρ_{S}ⁱ and ρ_{S}^{j} imposed by the user. Intermediate to the methodology is the construction of warping functions fₘⁱ and fₘ^{j} which will warp the axes zᵢ^{θ}and zⱼ^{θ}to map the Gaussian marginals on to ρₘⁱ and ρₘ^{j} and warping functions fₘⁱ and fₘ^{j} which will warp the axes zᵢ⁰ and zⱼ⁰ to map the Gaussian marginals on to ρ_{S}ⁱ and ρ_{S}^{j}. The mathematical details of the methodology are outlined below using subscript notation m, s to refer to both model and scenario distributions in the same expression:

Estimate the scenario mean vector \vec{μ}^{θ}(see definition) with components μᵢ^{θ}and covariance matrix Σ^{θ}with components Σᵢⱼ^{θ}of the distribution of U_{θ}_{ᵢ}^{i,η} and U_{θ}_{ᵢ}^{j,η} obtained from a bivariate simulation. Σ⁷⁴ and μ^{θ}define the bivariate Gaussian distribution gi ρ_{g}^{ij}=ρ_{g}^{ij}[μ^{θ}, Σ^{θ}].

We then claim that the distribution ρ_{m,S}^{ij} is the one obtained from distribution ρ_{g}^{ij} by warping the coordinates zᵢ^{θ}and zⱼ^{θ}so as to reproduce required marginal distributions ρ_{m,S}ⁱ and ρ_{m,S}^{j}.

The transformation functions f_{m,S}ⁱ and f_{m,S}^{j} for the warping must satisfy the integral condition:

$${\int }_{- ∞}^{{z}_{i}^{θ}} {\int }_{- ∞}^{{z}_{j}^{θ}} {ρ}_{m , s}^{ij} ( {ζ}_{i} , {ζ}_{j} ) ⅆ {ζ}_{i} ⅆ {ζ}_{j} = {\int }_{- ∞}^{{f}_{m , s}^{i} ( {z}_{i}^{θ} )} {\int }_{- ∞}^{{f}_{m , s}^{j} ( {z}_{j}^{θ} )} {ρ}_{g}^{ij} [ {μ}^{θ} , {\sum }^{θ} ] ( {ζ}_{i}^{′} , {ζ}_{j}^{′} ) ⅆ {ζ}_{i}^{′} ⅆ {ζ}_{j}^{′} . \qquad ( 7 )$$

Since our constraint is that the warping functions must reproduce the marginal distributions, we take zⱼ^{θ}=∞ in expression 7 and obtain:

$${\int }_{- ∞}^{{z}_{i}^{θ}} {ρ}_{m , s}^{i} ( {ζ}_{i} ) ⅆ {ζ}_{i} = {\int }_{- ∞}^{{f}_{m , s}^{i} ( {z}_{i}^{θ} )} {ρ}_{g}^{i} [ {μ}_{i}^{θ} , {\sum }_{ii}^{θ} ] ( {ζ}_{i}^{′} ) ⅆ {ζ}_{i}^{′} . \qquad ( 8 )$$

and the similar expression for the other component by setting i=j.

Expression 8 for i and j are the defining expressions for the functions f_{m,S}ⁱ and f_{m,S}^{j}.

Effectively f_{m,S}ⁱ represents a quantile to quantile mapping between the quantiles of the univariate Gaussian distribution ρ_{g}ⁱ[μᵢ^{θ}, Σᵢᵢ^{θ}] and the marginal distribution ρ_{m,S}ⁱ.

Taking the derivative of expression 7 with respect to both variables zᵢ^{θ}and zⱼ^{θ}we get:

$${ρ}_{m , s}^{ij} ( {z}_{i}^{θ} , {z}_{j}^{θ} ) = {ρ}_{g}^{ij} ( {f}_{m , s}^{i} ( {z}_{i}^{θ} ) , {f}_{m , s}^{j} ( {z}_{j}^{θ} ) ) ( \frac{ⅆ {f}_{m , s}^{i} ( z )}{ⅆ z} ) {{\vert}_{z = {z}_{i}^{θ}} \frac{ⅆ {f}_{m , s}^{j} ( z )}{ⅆ z} \vert}_{z = {z}_{j}^{θ}} . \qquad ( 9 )$$

Taking the derivative of expression 8 with respect to variable zᵢ^{θ}we get:

$$\frac{ⅆ {f}_{m , s}^{i} ( z )}{ⅆ z} {\vert}_{z = {z}_{i}^{θ}} = \frac{{ρ}_{m , s}^{i} ( {z}_{i}^{θ} )}{{ρ}_{g}^{i} ( {f}_{m , s}^{i} ( {z}_{i}^{θ} ) )} . \qquad ( 10 )$$

and the similar expression for the other component by setting i=j.

Using 10 we can rewrite 9 without the derivative so that:

$${ρ}_{m , s}^{ij} ( {z}_{i}^{θ} , {z}_{j}^{θ} ) = {ρ}_{g}^{ij} ( {f}_{m , s}^{i} ( {z}_{i}^{θ} ) , {f}_{m , s}^{j} ( {z}_{j}^{θ} ) ) ( \frac{{ρ}_{m , s}^{i} ( {z}_{i}^{θ} )}{{ρ}_{g}^{i} ( {f}_{m , s}^{i} ( {z}_{i}^{θ} ) )} ) ( \frac{{ρ}_{m , s}^{j} ( {z}_{j}^{θ} )}{{ρ}_{g}^{j} ( {f}_{m , s}^{j} ( {z}_{j}^{θ} ) )} ) \qquad ( 11 )$$

Expression 11 clearly shows that the system must be supported by a rapid subroutine which takes as input two univariate functions of the continuous distribution class (such as ρ_{m,S}ⁱ and ρ_{g}ⁱ) and provides as output a univariate continuous quantile to quantile mapping function (such as f_{m,S}ⁱ).

We can now rewrite 6 in the computable form:

$${ω}^{ij} ( {z}_{i}^{θ} , {z}_{j}^{θ} ) = \frac{{ρ}_{g}^{ij} ( {f}_{s}^{i} ( {z}_{i}^{θ} ) , {f}_{s}^{j} ( {z}_{j}^{θ} ) ) ( \frac{{ρ}_{s}^{i} ( {z}_{i}^{θ} )}{{ρ}_{g}^{i} ( {f}_{s}^{i} ( {z}_{i}^{θ} ) )} ) ( \frac{{ρ}_{s}^{j} ( {z}_{j}^{θ} )}{{ρ}_{g}^{j} ( {f}_{s}^{j} ( {z}_{j}^{θ} ) )} ) }{{ρ}_{g}^{ij} ( {f}_{m}^{i} ( {z}_{i}^{θ} ) , {f}_{m}^{j} ( {z}_{j}^{θ} ) ) ( \frac{{ρ}_{m}^{i} ( {z}_{i}^{θ} )}{{ρ}_{g}^{i} ( {f}_{m}^{i} ( {z}_{i}^{θ} ) )} ) ( \frac{{ρ}_{m}^{j} ( {z}_{j}^{θ} )}{{ρ}_{g}^{j} ( {f}_{m}^{j} ( {z}_{j}^{θ} ) )} )} . \qquad ( 12 )$$

Multivariate Generalization It should be clear that expressions 12 is completely generalizable to an arbitrary dimension. It is important to note that in this proposed implementation we shall construct weight function w^{ij . . .} only for i, j ε U_{S}. This means that the weight for a path defined by U^{i,η} for all i ε U is determined only by the vector \vec{U}_{θ}^{η}(see definition) built from the subspace of the simulation associated with U_{S}. The multivariate generalization of 12 gives the weight of path η as

$$ω ( η ) = ω ( {\vec{u}}_{θ}^{η} ) = \frac{( \frac{{ρ}_{g} [ {\vec{μ}}^{θ} , {\sum }^{θ} ] ( {f}_{s}^{i} ( {u}_{{θ}_{i}}^{i , η} ) ∀ i ∈ {u}_{s} )}{{\prod }_{i = 1}^{{N}_{{u}_{s}}} {ρ}_{g}^{i} [ {μ}_{i}^{θ} , {\sum }_{zi}^{θ} ] ( {f}_{s}^{i} ( {u}_{{θ}_{1}}^{i , η} ) )} ) {\prod }_{i = 1}^{{N}_{{u}_{s}}} {ρ}_{s}^{i} ( {u}_{{θ}_{i}}^{i , η} )}{( \frac{{ρ}_{g} [ {\vec{μ}}^{θ} , {\sum }^{θ} ] ( {f}_{s}^{i} ( {u}_{{θ}_{i}}^{i , η} ) ∀ i ∈ {u}_{s} )}{{\prod }_{i = 1}^{{N}_{{u}_{s}}} {ρ}_{g}^{i} [ {μ}_{i}^{θ} , {\sum }_{ii}^{θ} ] ( {f}_{s}^{i} ( {u}_{{θ}_{i}}^{i , η} ) )} ) {\prod }_{i = 1}^{{N}_{{u}_{s}}} {ρ}_{m}^{i} ( {u}_{{θ}_{i}}^{i , η} )} \qquad ( 13 )$$

Taking into consideration the explicit form:

$${ρ}_{g} ( {\tilde{z}}^{θ} ) = {ρ}_{g} [ {\vec{μ}}^{θ} , {\sum }^{θ} ] ( {\vec{z}}^{θ} ) = \frac{exp ( - {{\frac{1}{2} [ {\vec{z}}^{θ} - {\vec{μ}}^{θ} ] [ {\sum }^{θ} ]}^{- 1} [ {\vec{z}}^{θ} - {\vec{μ}}^{θ} ]}^{T} )}{\sqrt{{( 2 π )}^{{N}_{{u}_{s}}} \vert {\sum }^{θ} \vert}} \qquad ( 14 )$$

and introducing notation so that \vec{f}_{S}(\vec{z}^{θ}) is a vector with components fₘⁱ(zᵢ^{θ}) and \vec{f}ₘ(\vec{z}^{θ}) is a vector with components fₘⁱ(zᵢ^{θ}) we can write:

$$\begin{matrix}2 log ( ω ( η ) ) = {{[ {\vec{f}}_{m} ( {\vec{u}}_{θ}^{η} ) - {\vec{μ}}^{θ} ] [ {\sum }^{θ} ]}^{- 1} [ {\vec{f}}_{m} ( {\vec{u}}_{θ}^{η} ) - {\vec{μ}}^{θ} ]}^{T} - \\ {{[ {\vec{f}}_{s} ( {\vec{u}}_{θ}^{η} ) - {\vec{μ}}^{θ} ] [ {\sum }^{θ} ]}^{- 1} [ {\vec{f}}_{s} ( {\vec{u}}_{θ}^{η} ) - {\vec{μ}}^{θ} ]}^{T} + \\ {\sum }_{i = 1}^{{N}_{{u}_{s}}} {( {f}_{s}^{i} ( {u}_{{θ}_{i}}^{i , η} ) - {μ}_{i}^{θ} )}^{2} {\sum }_{ii}^{θ} - \\ {\sum }_{i = 1}^{{N}_{{u}_{s}}} {( {f}_{m}^{i} ( {u}_{{θ}_{i}}^{i , η} ) - {μ}_{i}^{θ} )}^{2} {\sum }_{ii}^{θ} + \\ {\sum }_{i = 1}^{{N}_{{u}_{s}}} log ( {ρ}_{s}^{i} ( {u}_{{θ}_{i}}^{i , η} ) ) - \\ {\sum }_{i = 1}^{{N}_{{u}_{s}}} log ( {ρ}_{m}^{i} ( {u}_{{θ}_{i}}^{i , η} ) )\end{matrix} \qquad ( 15 )$$

as the defining expression for ω(η). The evaluation of this expression requires paths to be stored because the estimation of ρ_{S}ⁱ, ρₘⁱ, \vec{μ}^{θ}and Σ^{θ}and the consequent estimation of fₘⁱ(ρₘⁱ,\vec{μ}ᵢ^{θ}, Σᵢᵢ^{θ}) and f_{S}ⁱ(ρ_{S}ⁱ, \vec{μ}ᵢ^{θ},Σᵢᵢ^{θ}) for all i ε U_{S} can only be determined from the full ensemble of paths η ε [1 . . . n_{S}].

Mean Vector of Asset Returns One objective of one embodiment of the Scenario Simulation System is to compute μ_{Δ}^{A}—so that [μ_{Δ}^{A}]ₖ is the mean expectation for a unit holding in asset k at the portfolio re-allocation horizon Δ taking into account all user scenarios ρ_{S}ⁱ for the underlying time series i ε U_{S}. We have shown that the manner in which we are able to include user scenarios is by weighting every multivariate simulation path η by the weight ω(η) computed using 15 which ensures realization of the user scenarios under the philosophy of least violent disturbance to model expectation. Having obtained the weights we can now specify that the components of μ_{Δ}^{A} are determined as:

$${[ {μ}_{Δ}^{𝒜} ]}_{k} = \frac{1}{{n}_{s}} {\sum }_{η = 1}^{{n}_{s}} ω ( η ) {A}_{k} ( {u}_{t}^{i , η} ∀ i ∈ {U}_{k} , ∀ t \leq Δ ) . \qquad ( 16 )$$

The Portfolio Allocation System will use this to estimate the return expectation of portfolios in the portfolio phase space ρ.

Covariance Matrix of Asset Returns The objective of the Scenario Simulation System is to compute Σ_{Δ}^{A}—the covariance matrix describing the expected distribution of returns for the universe of assets A at the portfolio re-allocation horizon Δ taking into account all user scenarios ρ_{S}ⁱ for the underlying time series i ε U_{S}. The covariance matrix must be computed with respect to the mean return for the involved assets and so using 16 we get:

$${[ {\sum }_{Δ}^{𝒜} ]}_{kl} = \frac{1}{{n}_{s}} {\sum }_{η = 1}^{{n}_{s}} ω ( η ) ( {A}_{k} ( {u}_{t}^{i , η} ∀ i ∈ {U}_{k} , ∀ t \leq Δ ) - {[ {μ}_{Δ}^{𝒜} ]}_{k} ) \times ( {A}_{l} ( {u}_{t}^{i , η} ∀ i ∈ {U}_{l} , ∀ t \leq Δ ) - {[ {μ}_{Δ}^{𝒜} ]}_{l} ) \qquad ( 17 )$$

The Portfolio Allocation System will use this along with μ_{Δ}^{A} to estimate the VaR (at prescribed confidence level) of portfolios in the portfolio phase space ρ.

6.1.6 Portfolio Allocation System

In one embodiment, the Portfolio Allocation System arrives at the efficient frontier for portfolio allocation taking μ_{Δ}^{A} and Σ_{Δ}^{A} as input. In another embodiment, the Portfolio Allocation System is seamlessly connected with the Scenario Simulation System and accounts for transaction costs proportional to the deviation of the proposed portfolio from the current portfolio. The seamless connection of the Portfolio Allocation System with the Scenario Simulation System also provides the opportunity to determine the optimal portfolio—or at least a local optimal—without making the Gaussian approximation of asset returns. This means that a more accurate VaR for the portfolio may be determined from the stored and re-weighted paths which can be made available to the Portfolio Allocation System by the Scenario Simulation System.

6.1.7 Dynamic scenarios

Overview In the Scenario Simulation Methodology section we mainly discussed the reweighting procedure which is used to accomplish the conditioning w.r.t. the static scenarios. We now discuss the impacts of dynamic scenarios on the system. They are of three kinds: volatility scenarios, correlation scenarios and drift scenarios.

Volatility and correlation scenarios are imposed on individual underlyings or on pairs of underlyings, respectively, and specify how these quantities have to be tweaked in order to reach a prescibed level at a given scenario horizon. We will present the basic tweaking mechanism in the Volatility and Correction Scenarios section.

By a drift scenario we mean a vector μ specifying constant drifts for some of the underlyings. This will have effects on the other (correlated) underlyings. The nature of this effect and how it can be treated is discussed in the Drift Models and Covariance section.

The first complication is due to the fact that the underlyings seen by the user do not correspond in all cases one to one to the time series used for the simulation. This happens e.g. for yield curves where the user sees spot rates but the simulation operates on forwards (at least for the pilot). We will call the domain seen by the user the ‘user domain’ and the internal domain the ‘system domain’. We assume that there is a linear isomorphism taking the system domain onto the user domain (see the Transformations Between User Domain and System Domain section).

Another transformation will be applied in the modelledData classes which transforms the underlying time series to the simulation time series. Typically this will be some kind of logarithmic transformation. This will be referred to as the ‘simulation domain’. We briefly comment on that in the Logarithmic Transformation section.

The final stage of complication arises if scenarios are not imposed on the user underlyings but on linear combinations thereof (e.g. spreads). The isomorphism (system domain)→(user domain) mentioned above should then be composed with the linear operator given by these linear functionals. This operator, however, will in general not be invertible. We come to this in the Scenarios for Linear Functionals of the Underlyings section.

In general, our process (still unconditioned w.r.t. the static scenarios) will be described by a discrete n-dimensional stochastic differential equation

X(t+1)=X(t)+v(t)+A(t)ε(t+1) (18)

where ε(t) is a normal random walk, i.e. i.i.d. normally distributed, and v(t) and A(t) are stochastic processes with values in Rⁿ respectively R^{n×n}.

For the simulation, the underlyings are arranged so that those with a drift scenario come first. This is needed for the method described in the Drift Models and Covariance section.

Disregarding for the moment the possibility of scenarios for spreads, the simulation step at time t proceeds as follows (we will present the algorithm in more detail in The Algorithm section).

1. Compute the model drifts and model covariance in the system domain. This is done in the modelledData classes using the diagonalVariance models and offDiagonalCovariance models.

2. Apply the isomorphism introduced in the Transformations Between User Domain and System Domain section to get into the ‘user domain’.

3. Tweak the volatilities/correlations and apply the Choleski decomposition to the tweaked covariance matrix.

4. Tweak the drifts according to the user scenarios. The Choleski factor and the inverse of its upper part are used for that.

5. Get a random vector ε(t) and compute dX(t) according to (18) (still in the user domain).

6. Transform dX(t) back into the system domain and update the time series in the system and simulation domain.

Volatility and Correlation Scenarios Volatility scenarios and correlation scenarios allow the user to tweak the volatility of/correlation between underlyings in a well defined way to reach a certain level at some future point in time. For each scenario, the user will supply the following:

a scenario horizon t

a volatility/correlation level a,

a monotonically increasing tweak function \hat{λ}: [0,1] → [0,1] satisfying \hat{λ}(0)=0 and \hat{λ}(1)=1.

It is conceivable that \hat{λ} will be chosen from a small set of system supplied functions such as {\hat{λ}(x)=x⁶⁵ : γ=½,1,3/2}.

If σ(t) is the volatility process of the simulation underlying under consideration and (\hat{σ}ⱼ,\hat{t}ⱼ,\hat{λ}ⱼ) the corresponding scenario, we define the volatility process for the scenario-adjusted underlying by

\hat{σ}(t)=(1−λ(t/\hat{t}))σ(t)+λ(t/\hat{t})\hat{σ}.

Here we have assumed that the process starts at t=0. The tweaking of a correlation element c(t) is done analogously.

If an element of the covariance matrix is tweaked, then no other element in that row or column may be tweaked. The proposed method to ensure positive definiteness of the tweaked covariance matrix is then the following.

if the correlation element cᵢⱼ(t) has been tweaked into ĉᵢⱼ(t), the new covariance element is defined by \hat{ρ}ᵢⱼ(t)=ĉᵢⱼ(t)√\overline{σᵢ(t)σⱼ(t)}.

if the volatility element σⱼ(t) has been tweaked into \hat{σ}ⱼ(t) then all covariance elements in the corresponding row and column are multiplied by \hat{σ}ⱼ(t)/σⱼ(t).

Drift Models and Covariance If drifts are imposed on some of the underlyings, they replace the corresponding model drifts. In addition to that, they will have an impact on all other (correlated) underlyings. Like for the static scenarios, the nature of this impact turns out to be determined by conditioning the process in the right way.

We start with the original model process which we assume being given by Y(t+1)=Y(t)+v(t)+A(t)ε(t+1). Here ε(t) are independent normal random variables and we assume for simplicity that A(t) is an n×n matrix. Suppose that we have a drift scenario μ⁽¹⁾=(μ₁, . . . , μₘ) for the first m<n coordinates. To ease the notation we henceforth drop the time index and set

Y⁽¹⁾=(Y₁, . . . , Yₘ), Y⁽²⁾=(Yₘ₊₁, . . . , Yₙ),

v⁽¹⁾=(v₁, . . . , vₘ), v⁽²⁾=(vₘ₊₁, . . . , vₙ),

ε⁽¹⁾=(ε₁, . . . , εₘ), ε⁽²⁾=(εₘ₊₁, . . . , εₙ).

There is no loss of generality if we assume that dY⁽¹⁾ is given as dY⁽¹⁾=v⁽¹⁾+Bε⁽¹⁾. This simply amounts to saying that the upper right block of A is zero (which is e.g. satisfied if A is the Cholesky factor of dY's covariance matrix). We then obtain the scenario-adjusted process for the first m coordinates by setting dX₍₁₎=μ⁽¹⁾+Bε⁽¹⁾.

Let P be the law of Y and Q⁽¹⁾ the law of X⁽¹⁾. If P⁽²⁾(dy\x) denotes the conditional law on R^{n-m} of P given x ε R^{m}, then Q(dx,dy)=Q⁽¹⁾(dx)P⁽²⁾(dy\x) is the joint law of dX⁽¹⁾ and dY⁽²⁾ given dX⁽¹⁾.

Remark. Note that if H is the set of probability measures on Rⁿ whose projection onto the first m coordinates coincides with Q⁽¹⁾, then Q(dx,dy) is the (unique, since H is convex and variation closed; ‘Csiszar's projection theorem’) measure in H of minimal entropy distance from P(dx,dy). Indeed, if R(dx,dy) is an arbitrary element of H, we have with notations as before

$${\int }_{{R}^{m} \times {R}^{n - m}} log \frac{R ( ⅆ x , ⅆ y )}{P ( ⅆ x , ⅆ y )} ⅆ R ( ⅆ x , ⅆ y ) = {\int }_{{R}^{m}} log \frac{{R}^{( 1 )} ( ⅆ x )}{{P}^{( 1 )} ( ⅆ x )} {\int }_{{R}^{n - m}} R ( ⅆ x , ⅆ y ) + {\int }_{{R}^{m} \times {R}^{n - m}} log \frac{ⅆ {R}^{( 2 )} ( ⅆ y \vert x )}{ⅆ {P}^{( 2 )} ( ⅆ y \vert x )} R ( ⅆ x , ⅆ y ) .$$

Both integrals are non-negative because of the convexity of x log x. Apart from P⁽¹⁾, the first integral only depends on R⁽¹⁾, which is constant for all R ε H. Since dQ⁽²⁾(dy\x)=dP⁽²⁾(dy\x), the second integral is zero for R=Q.

It remains to define X⁽²⁾ so that the law of X=(X⁽¹⁾,X⁽²⁾) is Q. For that, we write the matrix A as

$$A = [ \begin{matrix}B & 0 \\ C & D\end{matrix} ] , \qquad ( 19 )$$

where B is the upper m×m part of A as before and C and D are the remaining (n−m)×m and (n−m)×(n−m) blocks. Since dY⁽²⁾=v⁽²⁾+Cε⁽¹⁾+Dε⁽²⁾ and Y⁽¹⁾=v⁽¹⁾+Bε⁽¹⁾, we see that dY⁽²⁾ can be written as dY⁽²⁾=Z+\tilde{Z} where Z :=v⁽²⁾+CB⁻¹(dY⁽¹⁾−v⁽¹⁾) is measurable with respect to the sigma algebra σ(dY⁽¹⁾) and \tilde{Z}=Dε⁽²⁾ is (uncorrelated and therefore) independent of σ(dY⁽¹⁾). We get for x ε R^{m}

$$\begin{matrix}{P}^{( 2 )} ( ⅆ y \vert x ) = P [ Z + \tilde{Z} ∈ ⅆ y \vert ⅆ {Y}^{( 1 )} = x ] \\ = P [ \tilde{Z} ∈ ( ⅆ y - {v}^{( 2 )} - {CB}^{- 1} ( x - {v}^{( 1 )} ) ) \vert ⅆ {Y}^{( 1 )} = x ] \\ = P [ \tilde{Z} ∈ ( ⅆ y - {v}^{( 2 )} - {CB}^{- 1} ( x - {v}^{( 1 )} ) ) ] .\end{matrix}$$

So P⁽²⁾(dy\x) is the law of the random variable

dX⁽²⁾=dX⁽²⁾(x) :=\tilde{Z}+v⁽²⁾+CB⁻¹(x−v⁽¹⁾).

Replacing x by dX⁽¹⁾=μ⁽¹⁾+Bε⁽¹⁾ yields

$$\begin{matrix}{dX}^{( 2 )} = D {ϵ}^{( 2 )} + {v}^{( 2 )} + {CB}^{- 1} ( {μ}^{( 1 )} + B {ϵ}^{( 1 )} - {v}^{( 1 )} ) ) \\ = {v}^{( 2 )} + {CB}^{- 1} ( {μ}^{( 1 )} - {v}^{( 1 )} ) + C {ϵ}^{( 1 )} + D {ϵ}^{( 2 )}\end{matrix}$$

Introducing the time index again, we arrive at

$$dX ( t ) = [ \begin{matrix}{μ}^{( 1 )} \\ {v}^{( 2 )} ( t ) + C ( t ) {B ( t )}^{- 1} ( {μ}^{( 1 )} - {v}^{( 1 )} )\end{matrix} ] + A ( t ) ϵ ( t + 1 ) .$$

Transformations Between User Domain and System Domain In many cases, the underlyings which are seen by the user coincide with those that are used in the simulation except, say, for a logarithmic transformation. The latter wil be discussed in the next section.

In other cases, however, the simulation will operate on a different set of underlyings. The assumption made in this section is that the transformation between the system domain and the user domain is a linear isomorphism U.

Example. The typical example is interest rates where users will see spot rates R(t,sⱼ) for times to maturity 0 <s₁<. . . <sₖ but the simulation will be on the forwards R(t,sⱼ₋₁,sⱼ) for the periods [t+sⱼ₋₁,t+sⱼ], where we have put s₀=0. Since spots and forwards are related by the equation

(sⱼ−sⱼ₋₁)R(t,sⱼ₋₁,sⱼ)=sⱼR(t,sⱼ)−sⱼ₋₁R(t,sⱼ₋₁),

the isomorphism taking the spot-domain into the forward domain has the representation

$${( {U}_{forward \to spot} )}^{- 1} = [ \begin{matrix}1 & 0 & 0 & 0 & ⋯ \\ - \frac{{s}_{1}}{{s}_{2} - {s}_{1}} & \frac{{s}_{2}}{{s}_{2} - {s}_{1}} & 0 & 0 & ⋯ \\ 0 & - \frac{{s}_{3}}{{s}_{3} - {s}_{2}} & \frac{{s}_{2}}{{s}_{3} - {s}_{2}} & 0 & ⋯ \\ ⋮ & ⋮ & ⋮ & & ⋰\end{matrix} ] .$$

Note that in the following we will refer to the isomorphism U taking the user domain as a whole into the system domain. The matrix U_{forward→spot} is then a diagonal block of U.

The simulation models produce a covariance matrix Ω^{sys}=Ω^{sys}(t) and a model drift v^{sys}=v^{sys}(t) belonging to the system domain. These are transformed into the user domain as

Ω^{usr}=UΩ^{sys}U^{T}, v^{usr}=Uv^{sys}.

The volatility/correlation and drift tweaking is now performed on Ω^{usr} and v^{usr} as described in the previous sections. For the drift tweaking the Choleski factor A^{usr} of Ω^{usr} has to be computed.

Logarithmic Transformation The transformation of what has been called the system domain into the simulation domain (on which the actual Garch is imposed in most cases) poses no further problems. It just has to be noted at this point that the drift v^{sys} and covariance matrix Ω^{sys} still refer to the system domain. If the simulation domain is a ‘logarithmic domain’, i.e. if logarithmic differences are modelled, we will for instance have vⱼ^{sys}=Xⱼ^{sys}(vⱼ^{sim}+(σⱼ^{sim})²/2) and σⱼ^{sys}=Xⱼ^{sys}σⱼ^{sim}.

The Algorithm Putting everything together which has been discussed so far, we arrive at the following simulation algorithm for the simulation of one step into the future.

Compute the model drifts v^{sys} and model covariance Ω^{sys} in the system domain. This is done block-wise in the modelledData classes. The modelledData classes are also responsible for making the transformation from the simulation domain into the system domain.

Apply the universal isomorphism U to obtain v^{usr}=Uv^{sys} and Ω^{usr}=UΩ^{sys}U^{T}.

Do the volatility/correlation tweaking on Ω^{usr} to obtain a new matrix \hat{Ω}^{usr}. Make sure that \hat{Ω}^{usr} is positive definite!

Do a Choleski decomposition \hat{Ω}^{usr}=AA^{T} and break it up according to the drift scenario into the blocks B, C, D and 0 as described in the Drift Models and Covariance section.

Compute the scenario adjusted drift \hat{ν}^{usr} by setting \hat{ν}^{usr,(1)}=μ⁽¹⁾ and \hat{ν}^{usr(2)}=CB⁻¹(μ⁽¹⁾−ν^{usr,(1)}). Here μ⁽¹⁾ denotes the drift scenario which has to be imposed on the first m underlyings and the superscripts (1), (2) refer to the corresponding break-up of the vectors as in the Drift Models and Covariance section.

Get a normal random vector ε(t) from a random number generator and set dX^{usr}=\hat{ν}^{usr}+Aε.

Let dX^{sys}=U⁻¹dX^{usr} and update the time series in the system domain and in the simulation domain.

Scenarios for Linear Functionals of the Underlyings The most general case that has to be treated (as seen from now) is that users have views about linear functionals of the underlyings such as spreads. These may be of static or dynamic type. We again just addresss dynamic scenarios here; the reweighting in the static case actually presents no difficulty.

For the present discussion we view all scenarios as being imposed on linear functionals of the underlyings; in the ‘plain’ cases these functionals will just be represented by a basis vector. We call the functionals vⱼ,j=1, . . . ,m.

An important constraint that should possibly already be checked in the interface is that there are no contradictions in the scenarios. Since there are three differenct kinds of scenarios involved, it doesn't seem obvious what this really means. For the time being we interprete it as meaning that all vⱼ's should be linearly dependent of the others (there may be several scenarios for the same linear functional though, e.g. a volatility scenario and a drift scenario).

If the vⱼ are linearly independent, then of course we must have m≦n, i.e. there may be at most as many scenarios as underlyings. If m=n, then the operator V: Rⁿ→Rⁿ induced by the functionals is an isomorphism. If m<n, we can find more linear functionals υₘ₊₁, . . . ,υₙ such that the operator V made up of all the υⱼ's is an isomorphism on Rⁿ. In any case, we end up with an isomorphism VU taking the system domain onto the ‘linear functionals domain’. The tweaking of the resulting drift vector ν^{lf} and covariance matrix Ω^{lf} into \hat{ν}^{lf} and \hat{Ω}^{lf}, respectively, and the generation of the next simulated value can then be done in this new domain. The inverse of VU can be used to get back into the system domain.

It is not hard to see that the choice of υ⁽²⁾=(υₘ₊₁, . . . ,υₙ) is irrelevant with respect to the conditioning of the drifts. This is not true, however, with respect to the tweaking of the covariance matrix. It would seem ‘reasonable’ to choose the υ⁽²⁾ as an orthonormal basis of the orthogonal complement of the span of υ₁, . . . ,υₘ.

6.2 The OPAS Simulator

6.2.1 Introduction

The Olsen scenario-based Portfolio Allocation System is designed to give efficient portfolio allocations by combining statistical models on historical daily data with user inputs or scenarios about future behaviour of the underlying time series. The system supports various types of such scenarios, and the user is free to specify as many of them, with varying time horizons, as he or she wishes. The consistent integration of these inputs is one of the main important issues that has been addressed in the development of OPAS. The complexity of this task, together with the wish for using sophisticated time series modelling, has led to the development of a Monte Carlo simulator which is able to generate a conditioned stochastic process, taking into account the various scenarios pathwise and step by step. In this section we discuss the main technical aspects of this simulator.

The underlying time series in the OPAS simulation system can be of three different types:

FX-rates,

yield (discount) curves and

equity indices.

The simulated paths of underlyings are used to value a set of assets, which can be ‘any’ functions of the underlyings. Assets represent the financial instruments that the user is willing to invest in, i.e. the constituents of the possible portfolios. Valuation of assets in terms of underlyings will not be discussed here. For the simulation, the universe of assets only plays a role in so far as it determines the basic set of underlyings that has to be loaded and simulated. Moreover, the choice of the profit and loss currency and the specification of scenarios by the user can make it necessary to load and simulate additional underlyings.

In the Basic Volatility Models and the Basic Correlation Models sections we give precise definitions of the basic time series models for volatility and correlations that are available in OPAS. Since the set of underlyings to simulate is determined only at runtime, there is need for a certain ‘modularity’ in the way of modelling. This has to be achieved in such a way that the covariance matrix for the one day returns of the underlyings is guaranteed to be non-negative definite at each step of the simulation.

In the FX-Rates and Equity Indices and Interest Rates sections we take a closer look at how the basic time series models are applied to the actual time series at hand. One important issue is to decide what kind of returns to use for the modelling of volatility and correlations. For FX-rates and equity indices a good choice is to take relative returns or, what is similar and more common, logarithmic returns. Indeed, by making reference to stochastic calculus in the setting of continuous time semi-martingales, one can claim that the two are essentially the same. It should be noted, however, that in the discrete setting this involves a second order approximation which can be justified only as long as the one day changes are small in comparison with the price level, i.e. as long as the relative returns are near zero. Since this is not always the case for annualised interest rates, especially when they are very low, we may apply a slightly different transformation.

For interest rates there are further complications related to the modelling of the drift term. While, for FX-rates and equity indices, it can be justified to impose a ‘no-drift assumption’, such an assumption would be quite arbitrary in the case of rates. We will take the view that the one day return on a zero coupon risk free bond should, on average, be the overnight rate. Due to the stochastic nature of our models and the non-linearity of the transformation between bond prices and yields, this assumption implies a non-trivial drift term for annualised rates.

The Hole Filling section is devoted to a comprehensive description of the so called EM algorithm which is used for the handling of possible data holes.

The Drift Scenarios and Volatility and Correlation Scenarios sections deal with the conditioning of the time series models according to the user scenarios. These can be of four different types:

Level scenarios specify explicit drifts for certain underlyings, i.e. certain coordinates of the process. The task of the simulator is to determine the impact that these scenarios have on other underlyings. We will show that the corresponding conditioned process is obtained by adding a well defined drift term to the remaining coordinates.

Spread scenarios are similar to level scenarios except that the drifts apply to the difference of two coordinates. This is used for interest rate differentials; in fact, it is only available in that case. In order to determine the appropriately conditioned process we generalise our previous findings for level scenarios to the case of scenarios for arbitrary linear functionals of the coordinates.

Volatility scenarios affect the diagonal elements of the underlyings covariance matrix at each step of the simulation.

Correlation scenarios affect correlations between underlyings at each step of the simulation. This is done in a non-probabilistic, purely geometric fashion, which automatically preserves the positivity of the covariance matrix.

6.2.2 Basic Volatility Models

We briefly discuss the basic definitions of the volatility models that are in use in the OPAS simulation. In one embodiment, such models are not applied directly to the underlyings themselves but rather to some transformed time series, e.g. logarithmic returns. This issue will be taken up in the FX-Rates and Equity Indices and Interest Rates sections.

Rectangular Moving Average (RMA) and Historical Variance An often used estimator for the volatility of a time series Xₜ is the rectangular moving average

$${σ}_{RMA , t}^{2} = {σ}_{t}^{2} = \frac{1}{N} {\sum }_{i = 1}^{N} {X}_{t - i}^{2} . \qquad ( 20 )$$

For simulation purposes it is convenient to write this in recursive form as

σₜ₊₁²=σₜ²+1/N(Xₜ²−X_{t-N}²).

A related estimator is given by the statistical variance of the empirical measure,

$${σ}_{Hist , t}^{2} = {σ}_{t}^{2} = \frac{1}{N} {\sum }_{i = 1}^{N} {( {X}_{t - i} - {\overline{X}}_{t - 1} )}^{2} , \\ where {\overline{X}}_{t - 1} = \frac{1}{N} {\sum }_{i = 1}^{N} {X}_{t - i} \qquad ( 21 )$$

is the sample average. \overline{X}ₜ follows a similar recursive pattern as σ_{RMA,t}². We can take advantage of this fact by expressing σ_{Hist,t}² in the form

σ_{Hist,t}²=σ_{t,RMA}²−\overline{X}ₜ₋₁².

Remarks.

It is well known that (21) is a slightly biased estimator in the iid case; on the other hand, it is a natural estimator in a time series context since it coincides with the conventional definition of the zeroth sample autocovariance.

As functions of t, both σ_{RMA,t}² and σt,Hist² are sensitive to the value X_{t-N}. Exponential Moving Average (EMA) An exponential moving average is defined formally by

$${σ}_{t}^{2} = ( 1 - λ ) {\sum }_{i = 1}^{∞} {λ}^{i - 1} {X}_{t - i}^{2} , \qquad ( 22 )$$

for some 0<λ<1. (22) can be written in a recursive form as

σₜ²=(1−λ)Xₜ₋₁²+λσₜ₋₁². (23)

In practice, the recursion is started by setting

σₜ_{₀}_{-N+1}²=(1−λ)Xₜ_{₀}_{-N}²

for some large enough N, where to is the first index for which the volatility model is to be used.

For each subsequent t, σₜ² is then defined through (23). The buildup size N can be determined so that the cutoff is less than a certain threshold. Choosing for instance N≧−8/log λ yields λ^{N}=exp (−8)<0.0005. For λ=0.94 (the RiskMetrics default) this gives N>130 business days.

Remark. Sometimes the recursion is started by setting σₜ_{₀}_{-N+1}²=Xₜ_{₀}_{-N}², as Xₜ_{₀}_{-N}² can be considered to be ‘the best’ estimator for at, σₜ_{₀}_{-N+1}² based on just Xₜ_{₀}_{-N}. This means that for t≧t₀ we would get

$${σ}_{t}^{2} = ( 1 - λ ) {\sum }_{i = 1}^{N + t - {t}_{0}} {λ}^{i - 1} {X}_{t - i}^{2} + {λ}^{N + t - {t}_{0}} {X}_{{t}_{0} - N}^{2}$$

instead of just the sum cut off at N+t-t₀. However, this formula is not practical for our purposes (see e.g. the next section) and since N is explicitly chosen so that the difference is negligible, we stick to the definition given previously.

GARCH(1,1) A more flexible model than exponential moving average is provided by the GARCH(l, 1) model. As general references we mention Bollerskv T., 1986, Generalized Autoregressive Conditional Heteroskedasticity, Journal of Econometrics, 31, 307-327 and Gourieroux C., 1997, ARCH Models and Financial Applications, Springer Series in Statistics, Springer-Verlag, New York Berlin Heidelberg, the contents of which are herein incorporated by reference. In OPAS, this model is used as the default volatility model.

For parameters 0≦c, α, β<1, σₜ² is defined by the recursive formula

σₜ²=c+αXₜ₋₁²+βσ_{t-N}². (24)

Stepping the recursion n times gives

$${σ}_{t}^{2} = {\sum }_{i = 1}^{n} {β}^{i - 1} ( c + α {X}_{t - 1}^{2} ) + {β}^{n} {σ}_{t - n}^{2}$$

and we start the recursion by setting

σₜ_{₀}_{-N+1}²=c+αXₜ_{₀}_{-N}^{2.} (25)

The buildup size N is chosen≧−8/log β, in analogy with the EMA model.

Remark. When Xₜ is given as Xₜ=σₜεₜ with a standard normal random walk εₜ, then Xₜ is covariance stationary if and only if α+<1. In that case, for the unconditional variance we have

Var=E[Xₜ²]=E[σₜ²]=c+αE[Xₜ₋₁²]+βE[σₜ₋₁]=c+(α+β) Var,

so that c=(1−α−β) Var. We could therefore consider starting the recursion at σₜ_{₀}_{-N+1}=c/(1−α−β), at least when c>0. As in the case of the EMA model we stick to the structurally simpler definitioneq (25) for practical reasons.

6.2.3 Basic Correlation Models

In addition to a volatility model, the user can associate a model for correlation with each underlying. The available models are the same as the volatility models, i.e. historical, RMA, EMA and GARCH(1, 1). Now, however, these models are not used to define the volatility for the underlyings. Rather, they are combined pairwise to give formulas for the correlations between the underlyings. The essential task here is to define these correlations in such a way that the correlation matrix, and therefore the resulting covariance matrix, are non-negative definite.

In the historical, RMA and EMA volatility models, the variance can be expressed as the l₂-scalar product of a weighted time series (wᵢY_{t,i}) with itself We e.g. have in the case of historical variance

$${Y}_{t , i} = {X}_{t - i} - {\overline{X}}_{t - 1} and {w}_{i} = \{ \begin{matrix}1 & for i \leq N \\ 0 & for i > N\end{matrix}$$

while for the EMA model

$${Y}_{t , i} = {X}_{t - i} and {w}_{i} = \{ \begin{matrix}\sqrt{( 1 - λ ) {λ}^{i = 1}} & for i \leq N + t - {t}_{0} , \\ 0 & otherwise\end{matrix}$$

Such representations for the variance can immediately be generalised to corresponding formulas for covariance. Plainly, given weighted time series (w_{1,i}Y_{1,t,i}) and (w_{2,i},Y_{2,t,i}) corresponding to some basic time series X_{1,t} and X_{2,t} and associated volatility models, we can define the covariance for X_{1,t} and X_{2,t} by the scalar product of the weighted series,

$${Cov}_{t} = {\sum }_{i = 1}^{N} {w}_{1 , i} {w}_{2 , i} {Y}_{1 , t , i} {Y}_{2 , t , i} . \qquad ( 26 )$$

Accordingly, the correlation can be defined by

$${Cor}_{t} = \frac{{\sum }_{i = 1}^{N} {w}_{1 , i} {w}_{2 , i} {Y}_{1 , t , i} {Y}_{2 , t , i}}{{( {\sum }_{i = 1}^{N} {\vert {w}_{1 , i} {Y}_{1 , t , i} \vert}^{2} )}^{1 / 2} {( {\sum }_{i = 1}^{N} {\vert {w}_{2 , i} {Y}_{2 , t , i} \vert}^{2} )}^{1 / 2}} .$$

If the volatility models have different buildup sizes, it suffices in the definition of the covariance to sum up to the smaller of the two, i.e. to define N=N₁ΛN₂ where ‘Λ’ denotes the minimum.

At first glance, it may seem natural to define a covariance corresponding to two GARCH(1, 1) volatility models in a similar way by letting wᵢ=\sqrt{αβⁱ⁻¹} and adding the constant c=\sqrt{c₁c₂} to formula (26). The problem with this formula is that it is not bilinear as a function of the time series X_{1,t} and X_{2,t}. Especially, when X_{1,t} is replaced by −X_{1,t} then the resulting covariance does not just change sign as desired, as long as the sign of c is not changed as well. This shows that our definition of c was in fact arbitrary and could equally well be replaced by −c. In order to resolve this, we relate c to the time series Xₜ, which we assume to be of the form Xₜ=σₜεₜ with εₜ as defined before. It was mentioned before that in the stationary case, c=(1−α−β) Var, where Var is the unconditional variance of Xₜ. Given this, there are various possibilities to define c, e.g. by setting c=(1−α−β) \hat{Cov} where \hat{Cov} is the historical covariance over the buildup data. Alternatively, one could let \hat{Cov} be the historical covariance over a moving or growing window. In these cases, c would not depend on c₁ and c₂ at all and the covariance matrix could get non-positive definite if |c|>\sqrt{c₁c₂}. To remedy this, one might truncate c accordingly; in the case of a moving or growing window this would have to be done at each step. Still, this way of defining c seems undesirable since it would mean to largely ignore the user supplied parameters c₁ and c₂. For this reason, and to keep things simple, we define

c:=sign (\hat{Cov})\sqrt{c₁c₂} (27)

where \hat{Cov} denotes the historical covariance over the buildup data. This definition applies to the stationary and non-stationary case. If the covariance is to be defined with respect to a GARCH(1, 1) model and a model of another type such as RMA or EMA, then we let c=0.

We list the formulas which define the covariance corresponding to two volatility models explicitly in the following subsection. We emphasise once more that these definitions are used as part of the definition of the correlation of two underlyings. The model for the covariance of the underlyings then combines this with the respective models for volatilities which may be different than the models which are under consideration here.

Explicit Formulas Polarisation of (20) and (21) yields

$${Cov}_{RMA , t} ( {X}_{1} , {X}_{2} ) = \frac{1}{\sqrt{{N}_{1} {N}_{2}}} {\sum }_{i = 1}^{{N}_{1} ⋀ {N}_{2}} {X}_{1 , t - i} {X}_{2 , t - i}$$

$$and$$

$${Cov}_{Hist , t} ( {X}_{1} , {X}_{2} ) = \frac{1}{\sqrt{{N}_{1} {N}_{2}}} {\sum }_{i = 1}^{{N}_{1} ⋀ {N}_{2}} ( {X}_{1 , t - i} - {\overline{X}}_{1 , t - i} ) ( {X}_{2 , t - i} - {\overline{X}}_{2 , t - 1} ) ,$$

respectively. As for historical variance, (28) can readily be rewritten in terms of the recursive quantities \overline{X}_{1,t-1}, \overline{X}_{2,t-1} and Cov_{RMA,t}(X₁, X₂), namely as

$${Cov}_{Hist , t} ( {X}_{1} , {X}_{2} ) = {Cov}_{RMA , t} ( {X}_{1} , {X}_{2} ) - \frac{{N}_{1} ⋁ {N}_{2}}{\sqrt{{N}_{1} {N}_{2}}} {\overline{X}}_{1 , t - 1} {\overline{X}}_{2 , t - 1.}$$

As a ‘mixing’ between historical variance and RMA we define

$${Cov}_{Hist , RMA , t} ( {X}_{1} , {X}_{2} ) = \frac{1}{\sqrt{{N}_{1} {N}_{2}}} {\sum }_{i = 1}^{{N}_{1} ⋀ {N}_{2}} ( {X}_{1 , t - i} - {\overline{X}}_{1 , t - 1} ) {X}_{2 , t - i} , \qquad ( 28 )$$

which is the same as

$${Cov}_{Hist , RMA , t} ( {X}_{1} , {X}_{2} ) = {Cov}_{RMA , t} ( {X}_{1} , {X}_{2} ) - \frac{\sqrt{{N}_{2}}}{\sqrt{{N}_{1}}} {\overline{X}}_{1 , t - 1} {\overline{X}}_{2 , t - 1} .$$

An exponential moving average covariance can be defined by the recursive formula

Cov_{EMA,t}(X₁, X₂)=\sqrt{1−λ₁}\sqrt{1−λ²}X_{1,t}X_{2,t}+\sqrt{λ₁λ₂} Cov_{EMA,t-1}(X₁, X₂).

If t₀ is the first index at which the model is to be used and if e.g. N₁≦N₂, then we start the recursion by setting

Cov_{EMA,t}_{₀}_{-N}_{₁}₊₁(X₁, X₂)=\sqrt{1−λ₂}\sqrt{1−λ₁}λ₂^{(N}^{₂}^{-N}^{₁}^{)/2}X_{1,t}_{₀}_{-N}_{₁}X_{2,t}_{₀}_{-N}_{₁}. (29)

The formula for the case N₂<N₁ is analogous.

Remarks.

Note that if Nᵢ=−8/log λᵢ for i=1,2 and λ₁≠λ₂ then N<−8/log λ, i.e. the buildup size gets too small. It is therefore a good idea to choose Nᵢ large enough, for example Nᵢ=250 for all underlyings.

Note also that the constants \sqrt{1−λᵢ} in the above formulas are actually of no importance for the definition of the correlation since they also appear in the definition of the standard deviations in the denominator. A similar remark applies to the constants \sqrt{Nᵢ} in previous formulas.

An EMA with parameter λ, buildup size N and first index t₀ is ‘mixed’ with an RMA model with buildup size N′ by setting \hat{N}=(t-t₀+N)ΛN′ and

$${Cov}_{EMA , RMA , t} ( {X}_{1} , {X}_{2} ) = \frac{\sqrt{1 - λ}}{\sqrt{{N}^{′}}} {\sum }_{i = 1}^{\hat{N}} {λ}^{( i - 1 ) / 2} {X}_{1 , t - i} {Y}_{2 , t - i} .$$

Similarly we set

$${Cov}_{EMA , Hist , t} ( {X}_{1} , {X}_{2} ) = \frac{\sqrt{1 - λ}}{\sqrt{{N}^{′}}} {\sum }_{i = 1}^{\hat{N}} {λ}^{( i - 1 ) / 2} ( {X}_{1 , t - i} - {\overline{X}}_{1 , t - 1} ) {X}_{2 , t - i}$$

which can also be written as

$${Cov}_{EMA , Hist , t} ( {X}_{1} , {X}_{2} ) = {Cov}_{EMA , RMA , t} ( {X}_{1} , {X}_{2} ) - {\overline{X}}_{1 , t - 1} \frac{\sqrt{1 - λ}}{\sqrt{{N}^{′}}} {\sum }_{i = 1}^{\hat{N}} {λ}^{( i - 1 ) / 2} {X}_{2 , t - i} .$$

The case of GARCH(1, 1) models is analogous to the EMA model, replacing the EMA terms 1−λ by the corresponding GARCH(1, 1) parameter α. We do not repeat the formulas explicitly. The only difference worth recalling is that in the presence of two GARCH(1, 1) models, and only then, we add a constant c to the definition of the covariance as defined in (27).

Correlation of Residuals Given a time series Xₜ and a series of volatilities σₜ we define the residual series by Yₜ=Xₜ/σₜ. Any correlation model can naturally be applied to Yₜ instead of Xₜ.

Default Correlation Model By default, we use RMA correlations. Observe that the empirical correlations of a process which is simulated with GARCH(1, 1) volatilities and RMA conditional correlations does not have correlations of RMA type. Since a GARCH(1, 1) volatility model responds quicker to changes in the size of past squared returns than an RMA volatility model, the empirical correlations of the simulated process increase when the more recent squared returns are high and decrease otherwise. Note that a similar remark applies for the well known constant correlation GARCH(1, 1) model described in Bollerslev T., 1986, Generalized Autoregressive Conditional Heteroskedasticity, Journal of Econometrics, 31, 307-327 (the contents of which are herein incorporated by reference), which does by no means generate trivial empirical correlations.

6.2.4 FX-rates and Equity Indices

In the case of FX-rates and equity indices our basic models are drift free. For FX-rates, this is in accordance with empirical studies in Guillaume D. M., Dacorogna M. M., Dave R. D., Muller U. A., Olsen R. B., and Pictet O. V., 1997, From the Bird's Eye to the Microscope: A Survey of New Stylized Facts of the Intra-Daily Foreign Exchange Markets, Finance and Stochastics, 1, 95-129, the contents of which are herein incorporated by reference.

Assume that Uₜ is our global process for all underlyings and the i-th coordinate U_{i,t} is an FX-rate or equity index. Let Cₜ=ΣₜΣₜ^{T} be the covariance matrix for the increment Δₜ=Uₜ−Uₜ₋₁, and εₜ an n-dimensional standard normal random walk. In our case the dimension of εₜ is the same as that of Uₜ and Σₜ is chosen as a square matrix. The dynamics of U_{i,t} is then modeled as

U_{i,t}−U_{i,t-1}+Σ_{i·,t}·εₜ

where Σ_{i·,t} denotes the i-th row of Σₜ. The modelling of U_{i,t} is thus reduced to the modelling of the variance of Δ_{i,t,} which is given by |Σ_{i·,t}|², and its correlation with the other coordinates. We now drop the index i from our notation and consider just one underlying which is either an FX rate or an equity index. Since Δₜ is an absolute quantity whose average size presumably depends on the current level of U_{t,} we follow the common practice of applying the volatility and correlation models discussed in the previous sections to logarithmic returns

Xₜ :=log Uₜ−log Uₜ₋₁

instead of Δₜ. Since Uₜ/Uₜ₋₁ can be assumed to be close to 1, Xₜ is close to the relative return (Uₜ−Uₜ₋₁)/Uₜ₋₁.

For the absolute return At we now have

Δₜ=Uₜ₋₁(exp(Xₜ)−1)=Uₜ₋₁(Xₜ+Xₜ²/2+. . . )

Let \tilde{Δ}ₜ=Uₜ₋₁(Xₜ+Xₜ²/2) be the second order expansion of Δₜ. If we assume that the distribution of Xₜ conditional on Fₜ₋₁ is N(0, σₜ²) then we have E[Xₜ|Fₜ₋₁]=0. Therefore we get for the conditional mean of \tilde{Δ}ₜ

$$E [ {\tilde{Δ}}_{t} \vert {ℱ}_{t - 1} ] = {U}_{t - 1} E [ \frac{{X}_{t}^{2}}{2} \vert {ℱ}_{t - 1} ] = {U}_{t - 1} \frac{{σ}_{t}^{2}}{2}$$

and for the conditional variance

$$Var [ {\tilde{Δ}}_{t} \vert {ℱ}_{t - 1} ] = {E [ ( {\tilde{Δ}}_{t} - E [ {\tilde{Δ}}_{t} \vert {ℱ}_{t - 1} ] )}^{2} \vert {ℱ}_{t - 1} ] = {U}_{t - 1}^{2} E [ {( {X}_{t} + \frac{{X}_{t}^{2} - {σ}_{t}^{2}}{2} )}^{2} \vert {ℱ}_{t - 1} ] . \\ Since E [ {X}_{t} ( {X}_{t}^{2} - {σ}_{t}^{2} ) \vert {ℱ}_{t - 1} ] = {σ}_{t}^{3} E [ {ϵ}_{t} ( {ϵ}_{t}^{2} - 1 ) \vert {ℱ}_{t - 1} ] = 0 by symmetry and \\ E [ {( {X}_{t}^{2} - {σ}_{t}^{2} )}^{2} \vert {ℱ}_{t - 1} ] = {σ}_{t}^{4} E [ {( {ϵ}_{t}^{2} - 1 )}^{2} \vert {ℱ}_{t - 1} ] = 2 {σ}_{t}^{4}$$

we get Var [\tilde{Δ}ₜ|Fₜ₋₁]=Uₜ₋₁²σₜ²+σₜ⁴/2. Since Xₜ is assumed to be small, we have Δₜ≈\tilde{Δ}ₜ and σₜ⁴≈0, hence we can use the approximations

$$E [ {Δ}_{t} \vert {ℱ}_{t - 1} ] \approx {U}_{t - 1} \frac{{σ}_{t}^{2}}{2} , Var [ {Δ}_{t} \vert {ℱ}_{t - 1} ] \approx {U}_{t - 1}^{2} {σ}_{t}^{2} .$$

In a similar way one gets for underlyings U_{1,t} and U_{2,t} with analogous notations,

Cov [Δ_{1,t,} Δ_{2,t}|Fₜ₋₁]≈U_{1,t-1}U_{2,t-1}Cov [X_{1t,}X_{2,t}|Fₜ₋₁].

We arrive at the following transformation rule: if volatility and covariances are calculated for logarithmic returns of the i-th underlying then we multiply the i-th row and i-th column of the covariance matrix by Uₜ₋₁.

6.2.5 Interest Rates

Covariance Matrix With respect to volatility and scenario models, the main underlyings in the OPAS simulation system include annualised spot rates or actuarial rates a (t, s), where s≧0 denotes the time to maturity. The continuously compounded spot rate R(t, s) with time to maturity s is defined as

R(t, s)=log (1+α(t, s)).

It is reasonable to assume that (1+α(t, s))/(1+α(t-1, s)) is close to one so that

X(t, s)=R(t, s)−R(t-1, s) (30)

is a good approximation of the quantity

$$\frac{a ( t , s ) - a ( t - 1 , s )}{1 + a ( t - 1 , s )} .$$

Note that it would be problematic to assume that α(t, s)/α(t-1, s) is close to 1, especially when the rates are near zero.

Remark. Defining X(t, s) in this way is not uncustomary. Besides the increased numerical stability, an intuitive justification is given by the fact that X(t, s) is similar to a logarithmic return price series. Indeed, if we define a zero discount bond with constant time to maturity by \tilde{B}(t, s)=exp (−R(t, s)s) then

X(t, s)=−1/s(log \tilde{B}(t, s)−log \tilde{B}(t−1, s)).

By similar reasoning as in the last section we define the following relations between the conditional variance/covariance of Δ(t, s)=α(t, s)−α(t-1, s) and X(t, s) (with obvious notations):

Var(Δ(t, s)|Fₜ₋₁)=(1+α(t-1, s))²Var(X(t, s)|Fₜ₋₁),

Cov(Δ₁(t, s)Δ₂(t, s)|Fₜ₋₁) =(1+α₁(t-1, s))(1+α₂(t-1, s)) Cov(X₁(t, s)X₂ (t, s)|Fₜ₋₁).

The relation between actuarial and discount rates

For valuation purposes we need to be able to compute discount rates B (t, T) for arbitrary maturities T. If s=T−t is a benchmark maturity and N is the number of days per year, then B (t, T) is given as

B(t, T)=(1+α(t, s))^{-s/N} (31)

For intermediate maturities there is a choice to be made as to what kind of interpolation should be employed. Our approach is to transform the driving equations for α(t, s) into a corresponding set of stochastic differential equations for discount rates. This set of equations is then extended to a family of equations for arbitrary maturities by interpolating the drift and volatility coefficients. Suppose that the annualised rates are governed by the SDE

da(t, sᵢ)=μₐ(t, sᵢ)dt+σa(t, sᵢ)dWₜ. (32)

For convenience we set ŝ=s/N in what follows. Then the dynamics of \tilde{B} (t, sᵢ)=B (t, t+sᵢ) is

$$d \tilde{B} ( t , {s}_{i} ) = - {{\hat{s}}_{i} ( 1 + a ( t , {s}_{i} ) )}^{- {\hat{s}}_{i} - 1} da ( t , {s}_{i} ) + \frac{{\hat{s}}_{i} ( {\hat{s}}_{i} + 1 )}{2} {( 1 + a ( t , {s}_{i} ) )}^{- {\hat{s}}_{i} - 2} d < a ( \cdot , {s}_{i} ) {>}_{t} .$$

From this we readily get

$$\begin{matrix}\frac{d \tilde{B} ( t , {s}_{i} )}{ \tilde{B} ( t , {s}_{i} )} = {μ}_{\tilde{B}} ( t , {s}_{i} ) d t + {σ}_{\tilde{B}} ( t , {s}_{i} ) d {W}_{t} , with & ( 33 ) \\ {μ}_{\tilde{B}} ( t , {s}_{i} ) = - \frac{{\hat{s}}_{i}}{1 + a ( t , {s}_{i} )} {μ}_{a} ( t , {s}_{i} ) + \frac{{\hat{s}}_{i} ( {\hat{s}}_{i} + 1 )}{{( 1 + a ( t , {s}_{i} ) )}^{2}} \frac{{{σ}_{a} ( t , {s}_{i} )}^{2}}{2} \\ and {σ}_{\tilde{B}} ( t , {s}_{i} ) = - \frac{{\hat{s}}_{i}}{1 + a ( t , {s}_{i} )} {σ}_{a} ( t , {s}_{i} ) . & ( 34 )\end{matrix}$$

Linear interpolation of μ_{\tilde{B}} and σ_{\tilde{B}} yields equations of the form (33) for every s.

In practice, we use a discretized version of (33) for computing \tilde{B} (t, s) recursively from \tilde{B} (0, s). Note that the initial discount curve \tilde{B} (0, s) is available for every S. If X (t, s) denotes the interpolated value of the right hand side of (33), then

\tilde{B} (t+1, s)=\tilde{B} (t, s) (1+X(t, s)).

Zero Hypothesis From the foregoing it becomes apparent that in the context of interest rates it is not obvious what a ‘drift free’ hypothesis means. The non linear relationship between annualised (or continuously compounded) rates and discount rates allows at most one of the family of rates to have zero drifts. Moreover, since discount rates with constant maturity are the same as risk free zero coupon bond prices, another natural choice for the drift coefficient for the relative returns of B (t, T) is the one day short rate rₜ. We thus have the following possible choices in the ‘drift free’ setting.

(i) μ_{α} (t, s)=0,

(ii) μ_{\tilde{B}} (t,s)=0,

(iii) μ_{B} (t, T)=rₜ.

Condition (ii) translates into a drift for annualised rates straightforwardly. From (34) we get

$${μ}_{a} ( t , s ) = \frac{\hat{s} + 1}{1 + a ( t , s )} \frac{{{σ}_{a} ( t , s )}^{2}}{2} .$$

Condition (iii) is formulated in terms of discount rates with fixed maturities. In terms of the corresponding actuarial rate with fixed maturity A (t, T) :=α(t, T−t) we have B (t, T)=(1+A (t, T))^{-(T-t)/N}. In the application of Itô's formula we then have to include the derivative with respect to time, which yields in this case

$$\frac{d B ( t , T )}{ B ( t , T )} = \frac{1}{N} log ( 1 + A ( t , T ) ) d t - \frac{\hat{s}}{1 + A ( t , T )} d A ( t , T ) + \frac{\hat{s} ( 1 + \hat{s} )}{{( 1 + A ( t , T ) )}^{2}} d {⟨ A ( \cdot , T ) ⟩}_{t} . \\ Equating {r}_{t} = \frac{1}{N} log ( 1 + A ( t , T ) ) - \frac{\hat{s}}{1 + A ( t , T )} {μ}_{A} + \frac{\hat{s} ( 1 + \hat{s} )}{{( 1 + A ( t , T ) )}^{2}} d {⟨ A ( \cdot , T ) ⟩}_{t}$$

$$and observing that d {⟨ A ( \cdot , T ) ⟩}_{t} = d {⟨ a ( \cdot , T ) ⟩}_{t} ( since {σ}_{A} = {σ}_{a} ) and$$

$${μ}_{a} ( t , T - t ) = {μ}_{A} ( t , T ) + \frac{\partial }{\partial T} A ( t , T ) , \\ we get {μ}_{a} ( t , s ) = \frac{1 + a ( t , s )}{\hat{s}} ( \frac{1}{N} log ( 1 + a ( t , s ) ) - {r}_{t} ) + \frac{\partial }{\partial s} a ( t , s ) + \frac{1 + \hat{s}}{1 + a ( t , s )} \frac{{{σ}_{a} ( t , s )}^{2}}{2} .$$

Final Remark At this point it has to be stressed that the equivalence of (32) and (33) is a consequence of Itô's formula and is therefore based on the fundamental fact that (W)ₜ=t (Lévy's theorem). This does not carry over to our discrete setting. The corresponding identity would read ε²=1 for a standard normal variable, which is obviously meaningless. Because of this, we cannot define both annualised rates and discount rates by the discrete versions of (32) and (33). This would lead to inconsistency and the resulting values would not satisfy (31). Instead we use (32) only for the specification of the drift and volatility terms, compute discount rates as outlined above and then apply (31) to obtain the corresponding annualised rates.

In fact, the explicit calculation of a(t, s) is used only because of possible drift scenarios or inherited drifts. If there is a scenario implied drift term \tilde{μ}(t, s) for a(t, s) and μₐ(t, s) is the ‘model drift’, then the additional drift v(t,s) :=\tilde{μ}(t,s)−μₐ(t,s) has to be included in (33), leading to

$$\begin{matrix}B ( t + 1 , T ) = B ( t , T ) ( 1 + {r}_{t} + \frac{cs}{1 + a ( t , s )} ( v ( t , s ) + {σ}_{a} ( t , T ) \cdot {ϵ}_{t} ) ) \\ = B ( t , T ) ( 1 + {r}_{t} + \frac{cs v ( t , s )}{1 + a ( t , s )} + {σ}_{B} ( t , T ) \cdot {ϵ}_{t} ) .\end{matrix}$$

6.2.6 Forward Expectations

As an alternative to the ‘drift-free’ settings, the models can run in ‘forward-biased’ mode. This means that the model drifts are determined by forward prices.

Equity If Sₜ is the price of an asset at time t and B (t,T) denotes the discount factor in corresponding currency, then the forward price of the asset for time T>t is given by

$${F}_{S} ( t , T ) = \frac{{S}_{t}}{B ( t , T )}$$

This formula directly applies to equities and equity indices.

FX Let Cₜ be the exchange rate GBP-USD, say (i.e. the price of one pound in dollars), and denote the discount factors for USD and GBP by B (t,T) and D (t,T), respectively. The asset under consideration is thus the discounted pound, expressed in dollars, D (t,T) Cₜ. and the forward price is given by

$${F}_{C} ( t , T ) = \frac{D ( t , T )}{B ( t , T )} {C}_{t} .$$

Actuarial Rates The forward price of a zero-coupon bond (discount factor) with maturity T+Δ is B (t,T+Δ) is B (t,T)⁻¹ B (t,T+Δ), so that the forward annualised rate for the period Δ is given by

Fₐ (t,T,Δ)=1\Δ(B (t,T)\B(t,T+Δ)−1).

$${F}_{a} ( t , T , Δ ) = \frac{1}{Δ} ( \frac{B ( t , T )}{B ( t , T + Δ )} - 1 ) .$$

6.2.7 Hole Filling

Financial time series are seldom complete in the sense that there is a true observed price available for every single business day. The cause of such holes in the data can e.g. be related to public holidays in certain countries or to technical problems of the data collector or provider. The most straightforward way of dealing with such holes is to replace the missing points by linearly interpolated prices or even just previous days prices. This approach, however, ignores any statistical information that the available data may give regarding the missing points.

The EM algorithm One commonly applied method which aimes at using statistical knowledge for filling data holes is the so-called expectation maximisation algorithm, EM algorithm for short. This is an iterative algorithm which, by assuming a parametric distribution for the hypothetical complete data, i.e. including the missing points, maximises the marginal likelihood at the observed data. Once the maximum likelihood parameters have been found, the missing prices are filled in by their conditional expectations under that model, given the observed data.

In more precise terms, the algorithm can be described as follows. Denote the observed data by y and the hypothetical complete time series by x. Assume a parametric density f (x,θ) for the distribution of x. Given a parameter estimate θ^{(p)} at the p-th iteration of the algorithm, θ^{(P+1)} is obtained by maximising the conditional expectation, under the θ^{(P)} model, of the log-likelihood log f(x,θ), given the observed data y:

$${θ}^{( p + 1 )} := arg {max}_{θ} {E}_{θ ( p )} [ log f ( x , θ ) \vert y ] . \qquad ( 35 )$$

Starting from some initial estimate θ⁽¹⁾ the iteration continues until some termination criterion is fulfilled, and the complete time series is defined through E_{θ}[x|y] for the final parameters θ. If g(y,θ) denotes the marginal distribution of f (x,θ) then it can be shown in many cases, including the case where {ƒ(x,θ),θεΘ} is an exponential family, that the algorithm indeed converges to the maximum likelihood estimate of g(y,θ). This is further described in Dempster A. P., Laird N. M., and Rubin D. B., 1977, Maximum Likelihood from Incomplete Data via the EM Algorithm, Journal of the Royal Statistical Society, Series B, 39(2), 1-38, the contents of which are herein incorporated by reference.

The Gaussian Case We employ the EM algorithm in the simplest case, assuming that the data is independent identically Gaussian distributed. Of course, this model is not applied to the data itself but rather to the return price series as discussed in the previous sections. The parameter set θ thus consists of a mean vector μ and a covariance matrix C. To start the iteration, we define a first completed data set x⁽¹⁾ by linear interpolation and let θ⁽¹⁾=(μ⁽¹⁾, C⁽¹⁾) be the sample mean and sample covariance of x⁽¹⁾.

Denoting the dimension and length of the time series by n and T, respectively, the log-likelihood for θ=(μ,C) is given as

$$- \frac{nT}{2} log 2 π - \frac{T}{2} log det ( C ) - \frac{1}{2} {\sum }_{t = 1}^{T} ⟨ {x}_{t} - μ , {C}^{- 1} ( {x}_{t} - μ ) ⟩ .$$

Disregarding the constant −(nT log 2π)/2, the conditional expectation in (35) can therefore be written

$$- \frac{T}{2} log det ( C ) - \frac{1}{2} {\sum }_{t = 1}^{T} {E}_{{θ}^{( p )}} [ ⟨ {x}_{t} - μ , {C}^{- 1} ( {x}_{t} - μ ) ⟩ \vert y ] . \qquad ( 36 )$$

The parameters μ and C which maximise (35) can be found in a similar way as for ordinary maximum likelihood estimation, except that the conditional expectation with respect to E_{θ}_{^{(p)}} has to be taken into account. For the convenience of the reader, we outline the proof of the following proposition.

Proposition. Under our assumptions, (35) is maximised for

$$\hat{μ} := {E}_{{θ}^{( p )}} [ \overline{x} \vert y ] and \hat{C} = {E}_{{θ}^{( p )}} [ Q \vert y ] , where$$

$$\overline{x} = ( {\sum }_{t - 1}^{T} {x}_{t} ) / T and Q = ( {\sum }_{t - 1}^{T} ( {x}_{t} - \hat{μ} ) ⊗ ( {x}_{t} - \hat{μ} ) ) / T .$$

Proof. We first consider maximisation with respect to μ. The symmetry of C⁻¹ yields

$${\sum }_{t = 1}^{T} {E}_{{θ}^{( p )}} [ ⟨ {x}_{t} - μ , {C}^{- 1} ( {x}_{t} - μ ) ⟩ \vert y ] = {\sum }_{t = 1}^{T} {E}_{{θ}^{( p )}} [ ⟨ {x}_{t} , {C}^{- 1} {x}_{t} ⟩ \vert y ] - 2 T ⟨ {C}^{- 1} μ , {E}_{{θ}^{( p )}} [ \overline{x} \vert y ] ⟩ + T ⟨ μ , {C}^{- 1} μ ⟩ .$$

Applying Cauchy's inequality to the scalar product induced by C^{-½}yields

$$\begin{matrix}\vert ⟨ {C}^{- 1} μ , {E}_{{θ}^{( p )}} [ \overline{x} \vert y ] ⟩ \vert \leq {⟨ {C}^{- 1} μ , μ ⟩}^{1 / 2} {⟨ {C}^{- 1} {E}_{{θ}^{( p )}} [ \overline{x} \vert y ] , {E}_{{θ}^{( p )}} [ \overline{x} \vert y ] ⟩}^{1 / 2} \\ \leq \frac{1}{2} ⟨ {C}^{- 1} μ , μ ⟩ + \frac{1}{2} ⟨ {C}^{- 1} {E}_{{θ}^{( p )}} [ \overline{x} \vert y ] , {E}_{{θ}^{( p )}} [ \overline{x} \vert y ] ⟩ .\end{matrix}$$

There is equality of the first and last expression if and only if μ=E_{θ}_{^{(p)}}[\overline{x}|y]. From this it readily follows that, for any choice of C, (35) is maximised with respect to μ by choosing \hat{μ}=E_{θ}_{^{(p)}}[\overline{x}|y].

Since \hat{μ} does not depend on C, we can plug it into (36). Then (36) can be written as

−T\2 log det(C)−T\2 trace (C⁻¹E_{θ}_{^{(p)}}[Q|y]).

The claim now follows from the general fact that for any positive definite A, the function f(C)=log det(C)+trace (C⁻¹A) is minimised among all positive definite matrices C at C=A, see e.g. Seber, G. A. F., 1984, Multivariate Observations, John Wiley & Sons, Section 3.2.1, the contents of which are herein incorporated by reference. □

The serial independence implies E_{θ}_{^{(p)}} [xₜ|y]=E_{θ}_{^{(p)}} [xₜ|yₜ] as well as E_{θ}_{^{(p)}} [x_{t\mathring{x} x}ₜ|y]=E_{θ}_{^{(p)}} [xₜ \mathring{x} xₜ|yₜ ]. We can therefore write

$$\hat{μ} = \frac{1}{T} {\sum }_{t = 1}^{T} {E}_{{θ}^{( p )}} [ {x}_{t} \vert {y}_{t} ] and \hat{C} = \frac{1}{T} {\sum }_{t = 1}^{T} {E}_{{θ}^{( p )}} [ {x}_{t} ⊗ {x}_{t} \vert {y}_{t} ] - \hat{μ} ⊗ \hat{μ} .$$

Furthermore, the term E_{θ}_{^{(p)}} [xₜ \mathring{x} xₜ|yₜ ] can be expressed in terms of the conditional covariance matrix and conditional expectation, namely

E_{θ}_{^{(p)}} [xₜ \mathring{x} xₜ|yₜ ]=Cov_{θ}_{^{(p)}} (xₜ|yₜ)+E[xₜ|y_{t ] \mathring{x}} E[xₜ|yₜ].

To obtain explicit formulas for \hat{μ} and Ĉ it therefore suffices to determine the conditional mean and covariance given yₜ. Of course, E[xₜ|yₜ ] coincides with yₜ wherever yₜ is available. The matrix E[xₜ \mathring{x} xₜ|yₜ ] equals y_{t,i}y_{t,j} if both y_{t,i} are known, and it equals y_{t,i}E[xₜ|yₜ]ⱼ if only y_{t,i} is known. It thus only remains to determine the conditional mean and covariance matrix for the coordinates which are in hole. This is achieved by the following well-known lemma (see e.g. Brockwell P. J. and Davis R. A., 1991 Time Series: Theory and Methods, Springer Series in Statistics, Springer, New York Berlin Heidelberg, 2nd edition, the contents of which are herein incorporated by reference, Proposition 1.6.6 for proof).

Lemma. If Y ₛᵢₘN(μ,C) and Y₁, Y₂ denote the first m respectively remaining n−m coordinates, then the distribution of Y₂ conditional on Y₁=y₁ε R^{m} is N(\tilde{μ}₂, \tilde{C}₂₂) with

\tilde{μ}₂=μ₂+C₂₁C₁₁⁻¹(y₁−μ₁), \tilde{C}₂₂=C₂₂−C₂₁C₂₁C₁₂⁻¹.

Here μ and C are written in block form in the obvious way.

6.2.8 Drift Scenarios

Drift scenarios can be specified either for underlyings themselves or, in the case of interest rates, for the difference of two underlyings. The basic scenario models apply to absolute returns Δ(t)=U(t)−U(t-1), not logarithmic returns. Drift scenarios are not interpreted as becoming part of the time series model, but rather as a sort of boundary condition on the original model equation. This means that if drift scenarios are specified for some underlyings, this has an impact on the whole process which is determined by probabilistic conditioning. We first discuss the case where the scenarios act directly on the coordinates of the process. Then we consider scenarios for differences of coordinates; in fact, to make the discussion general, we treat drift scenarios for arbitrary linear functionals of the coordinates.

Drift Inheritance in the Simple Case Consider a discrete-time n-dimensional semi-martingale of the form

U(t+1)=U(t)+v(t)+Σ(t)ε(t) (37)

with v(t) ε Rₙ and Σ(t) ε R^{n×k}, both possibly themselves adapted stochastic processes. ε denotes an iid standard normal sequence in Rₙ. We call (37) our model equation. Note that U(t) will not, in general, be a Markov process (e.g. GARCH).

Let 1 ≦m ≦n and rewrite (37) as

$$\begin{matrix}{U}_{1} ( t + 1 ) = {U}_{1} ( t ) + {v}_{1} ( t ) + [ {\sum }_{11} {\sum }_{12} ] ( t ) ϵ ( t ) , & ( 38 ) \\ {U}_{2} ( t + 1 ) = {U}_{2} ( t ) + {v}_{2} ( t ) + [ {\sum }_{21} ( t ) {\sum }_{22} ( t ) ] ϵ ( t ) , & ( 39 )\end{matrix}$$

where U₁ and U₂ denote the first m and last n−m coordinates of the process, respectively, and v and Σ are written in corresponding block form. Our drift scenario now comes in the form of an m-dimensional drift process μ₁(t). Of course we assume, without any loss, that the scenarios apply to the first m coordinates.

Given the scenario μ₁, we replace (38) by

Û₁(t+1)=Û₁(t)+μ₁(t)+[Σ₁₁(t) Σ₁₂(t)]ε(t).

It remains to determine what happens with U₂ given the modified process Û₁. Here we can once more employ the lemma given at the end of the Hole Filling section. Writing Y(t) for the increment U(t+1)−U(t) and dropping henceforth the index t from our notation, that lemma yields an equation for Ŷ₂, namely

Ŷ₂=v₂+C₂₁C₁₁⁻¹(Ŷ₁−v₁)+(C₂₂−C₂₁C₁₁⁻¹C₁₂)^{½}ε₂, (40)

where Ŷ₁ is given by

Ŷ₁ =μ₁+C₁₁^{½}ε₁. (41)

We can obtain a simpler representation of Ŷ₂ by looking at a factorisation C=ΣΣ^{T} where Σ ε R^{n×n} with Σ₁₂ =0 (this is always possible). We then have Σ₂₁Σ₁₁⁻¹=C₂₁C₁₁⁻¹ and therefore from (41)

$$\begin{matrix}{C}_{21} {C}_{11}^{- 1} ( {\hat{Y}}_{1} - {v}_{1} ) = {C}_{21} {C}_{11}^{- 1} ( {\hat{Y}}_{1} - {μ}_{1} ) + {C}_{21} {C}_{11}^{- 1} ( {μ}_{1} - {v}_{1} ) \\ = {\sum }_{21} {\sum }_{11}^{- 1} ( {\hat{Y}}_{1} - {μ}_{1} ) + {C}_{21} {C}_{11}^{- 1} ( {μ}_{1} - {v}_{1} ) \\ = {\sum }_{21} {ϵ}_{1} + {C}_{21} {C}_{11}^{- 1} ( {μ}_{1} - {v}_{1} ) .\end{matrix}$$

Moreover, it is readily seen that Σ₂₂ Σ₂₂^{T}C₂₂−C₂₁C₁₁⁻¹C₁₂, so that we can rewrite (40) as

iŶ₂=v₂+C₂₁C₁₁⁻¹(μ₁−v₁)+[Σ₂₁ Σ₂₂] ε.

This means that Ŷ₂ is obtained from Y₂=v₂+[Σ₂₁ Σ₂₂] ε by simply adding a drift term C₂₁C₁₁⁻¹(μ₁−v₁). In other words, we end up with the representation

$$\hat{Y} = Y + [ \begin{matrix}{μ}_{1} - {v}_{1} \\ {C}_{21} {C}_{11}^{- 1} ( {μ}_{1} - {v}_{1} )\end{matrix} ]$$

or, written in terms of our original process equation

$$\hat{U} ( t + 1 ) = \hat{U} ( t ) + v ( t ) + [ \begin{matrix}{μ}_{1} ( t ) - {v}_{1} ( t ) \\ {C}_{21} ( t ) {C}_{11}^{- 1} ( t ) ( {μ}_{1} ( t ) - {v}_{1} ( t ) )\end{matrix} ] + \sum ( t ) ϵ ( t ) . \qquad ( 42 )$$

Drift Inheritance in the General Case Starting from our model equation (37) we now assume that we are given m linear functionals vᵢ: Rⁿ → R and drift scenarios μᵢ(t) which are to be applied to vᵢY(t) for i=1, . . . , m. A necessary condition on the vᵢ is clearly that they are linearly independent; otherwise the system would be overspecified. We again write μ₁(t) for the m dimensional vector (μ₁(t), . . . ,μₘ(t)) and similarly V₁ for the m×n matrix consisting of all vᵢ.

Our aim is to replace Y :=Y(t) :=U(t+1)−U(t) by a process Ŷ so that V₁Ŷ is Gaussian distributed with mean μ₁ and covariance V₁ΣΣ^{T}V₁^{T}=V₁CV₁^{T}. Since V₁ has rank m, we can find a (n−m)×n matrix V₂ so that

$$V = [ \begin{matrix}{V}_{1} \\ {V}_{2}\end{matrix} ]$$

is invertible. Denoting \tilde{Σ}=VCV^{T} we have VYₛᵢₘN(Vv,\tilde{Σ}). Applying the results of last section to VY gives

$$\begin{matrix}{V}_{1} \hat{Y} = {V}_{1} Y + ( {μ}_{1} {V}_{1} υ ) & ( 43 ) \\ {V}_{2} \hat{Y} = {V}_{2} Y + {\tilde{\sum }}_{21} {\tilde{\sum }}_{11}^{- 1} ( {μ}_{1} - {V}_{1} υ ) . \\ \text{Now define} \\ U := {CV}_{1}^{T} {\tilde{\sum }}_{11}^{- 1} = {{CV}_{1}^{T} ( {V}_{1} {CV}_{1}^{T} )}^{- 1} . & ( 44 )\end{matrix}$$

Then V₁U=id_{R}_{^{m}} and V₂U=\tilde{Σ}₂₁\tilde{Σ}₁₁⁻¹ so that

$$V ( υ + U ( {μ}_{1} - {V}_{1} υ ) ) = [ \begin{matrix}{μ}_{1} \\ {V}_{2} υ + {\tilde{\sum }}_{21} {\tilde{\sum }}_{11}^{- 1} ( {μ}_{1} - {V}_{1} {υ}_{1} )\end{matrix} ]$$

which is our desired drift for V\tilde{Y} (see (42)). In order to define \tilde{Y} it therefore suffices to replace the drift v by the new drift

\hat{v}:=v+U(μ₁−V₁v).

Note that U is defined in terms of C and V₁ only, i.e. it is not necessary for the definition of \hat{v} to actually choose V₂ explicitly.

6.2.9 Volatility and Correlation Scenarios

In addition to drift scenarios, the OPAS simulation system is able to handle another type of boundary conditions, namely views about volatilities and correlations of the underlyings at some future point in time. The main important issue here is to change the covariance matrix of underlyings in a way that preserves its non-negative definiteness.

Volatility Scenarios Volatility scenarios allow the user to tweak the volatility between underlyings to reach a certain level at some future point in time. For each scenario, the user will supply the following:

a scenario horizon \hat{t},

a final volatility \hat{σ},

a monotonically increasing tweak function \hat{λ} : [0,1] →[0,1] satisfying \hat{λ}(0)=0 and \hat{λ}(1)=1.

In fact, \hat{λ}(s) is always chosen to be one of √\overline{s}, s or s².

Volatility tweaking is straightforward. If the volatility σₓ of an underlying x has to be tweaked according to the scenario (\hat{σ},\hat{t},\hat{λ}), we define

\hat{σ}(t)=(1−λ(t/\hat{t}))σₓ(t)+λ(t/\hat{t})\hat{σ}. (45)

Here we have assumed that the process starts at t=0. The covariance C_{x,y}(t) between x and an arbitrary underlying y≠x is then recalculated so as to keep the correlation between x and y unchanged, i.e. we set

$${\hat{C}}_{x , y} ( t ) := {C}_{x , y} ( t ) \frac{{\hat{σ}}_{x} ( t )}{{σ}_{x} ( t )} .$$

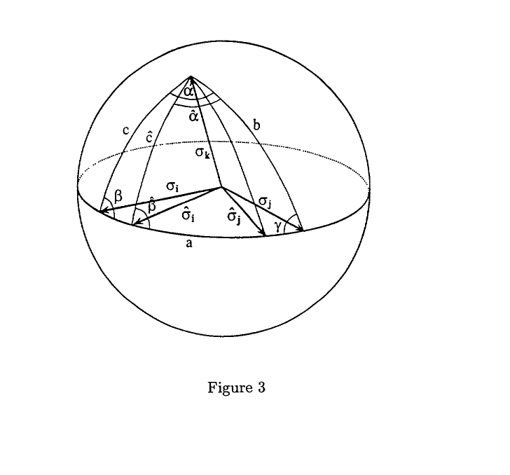

Correlation Scenarios FIG. 3 illustrates a 3-dimensional subspace Rⁿ used to explain the correlation scenarios. Correlation scenarios are specified in an analogous way as volatility scenarios. A scenario for the correlation between underlyings x and y has the form (ĉ,\hat{t},\hat{λ}), which results in a tweaked correlation function given as

ĉ_{x,y}(t)=(1−λ(t/\hat{t}))c_{x,y}(t)+λ(t/\hat{t})ĉ. (46)

In contrast to volatility scenarios, correlation scenarios cannot always be fully satisfied since the set of scenarios alone may already imply a non positive definite covariance matrix. Instead of trying to find a covariance matrix with minimal distance to the original matrix with respect to some norm (this is in fact impossible since the cone of positive matrices is open with respect to any norm), we proceed in a successive way which guarantees non negativity of the resulting matrix at each step.

We describe only one step of this iterative procedure, i.e. how to handle a single correlation scenario. In the following, C denotes the correlation matrix of the process and Σ is an n×n matrix with C=ΣΣ^{T}. Write σᵢ for the i-th row of Σ. Denoting euclidean norm and inner product by |•| and <•, •>respectively, we have a σᵢ²=<σᵢ,σᵢ>=Cᵢᵢ=1 for all i, i.e. each σᵢ can be seen as a unit vector in Rⁿ. Moreover, Cᵢⱼ=<σᵢ,σⱼ> is just the cosine of the angle between σᵢ and σⱼ for i≠j. We now interpret a tweak of Cᵢⱼ as moving σᵢ and σⱼ on the unit sphere of Rₙ towards or away from each other by equal amounts on their geodesic until they have the requested angle. Then it remains to recalculate the angles between the new vectors \hat{σ}ᵢ, \hat{σ}ⱼ and all remaining σₖ.

Remark. These geometrical considerations reveal why tweaking an element of the correlation matrix without ‘inheritance mechanism’, i.e. without recomputing all correlations on the same row and column, often leads to a non-positive matrix. Indeed, non-negativity would only be preserved if it were possible to adjust the position of the two vectors while keeping all other angles the same. This is often not possible.

For this algorithm to work, it is in fact not necessary to actually carry out the factorisation C=ΣΣ^{T} (which would have to be done at each step of the iterative procedure). Using elementary spherical trigonometry we can compute the new angles directly from the old ones, which are given by C. Assume that Cᵢⱼ has been tweaked into Ĉᵢⱼ and let k≠i,j arbitrary. In terms of the above vectors this means that σᵢ and σⱼ have been replaced by some new vectors \hat{σ}ᵢ and \hat{σ}ⱼ. Since \hat{σ}ᵢ and \hat{σ}ⱼ are chosen on the geodesic of σᵢ and σⱼ, all five vectors σᵢ, σⱼ, σₖ, \hat{σ}ᵢ, \hat{σ}ⱼ are elements of the same 3-dimensional subspace of Rₙ and can therefore all be seen as elements of the same sphere S₂={x εR³ : |x |=1}.

We now concentrate on the angle between \hat{σ}ᵢ and σₖ, that is on Ĉᵢₖ. The two triples (σᵢ, σⱼ, σₖ) and (\hat{σ}ᵢ, σⱼ, σₖ) describe two triangles on S₂ whose sides have arc lengths

| | | | |
|---|---|---|---|
| a = acos < σᵢ, σⱼ >, | b = acos < σⱼ, σₖ >, | c = acos < σₖ, σᵢ > | and |
| â = acos < \hat{σ}ᵢ, σⱼ >, | b = acos < σⱼ, σₖ >, | ĉ = acos < σₖ, \hat{σ}ᵢ >, | |

respectively. The known quantities here (without having to factorise C) are a=a cos Cᵢⱼ, b=a cos Cⱼₖ and c=a cos Cᵢₖ. Moreover, â=a cos <\hat{σ}ᵢ, σⱼ > can readily be obtained from Cᵢⱼ and Ĉᵢⱼ by our assumption that σᵢ and σⱼ are moved on their geodesic by equal amounts. The task is to determine ĉ=a cos Ĉᵢₖ in terms of these known quantities.

We label the angles of the two triangles in the usual way by α, β, γ and \hat{α}, \hat{β}, γ, see FIG. 3.

The first cosine theorem of spherical trigonometry, applied to the second triangle, states that

cos ĉ=sin b sin â cos γ+cos b cos \hat{a}.

Applying the same theorem to the first triangle yields

cos γ=cos c−cos b cos a/sin b sin a,

so that we end up with

$$cos \hat{c} = \frac{sin \hat{ α}}{sin α} cos c + ( cos \hat{α} - cos α \frac{sin \hat{α}}{sin α} ) cos b .$$

In other words,

ĈᵢₖλCᵢₖμCⱼₖ

with λ=sin â/ sin a and μμcos â−cos a sin â/ sin a.

Note that the algorithm is quite efficient since λ and μ depend only on a and â, but not on k.

6.2.10 Summary

We summarise what has been discussed in this section.

The covariance matrix for the absolute returns Δₜ=Uₜ−Uₜ₋₁ of the underlyings is constructed by applying basic volatility and correlation models to logarithmic returns (for FX-rates and equity indices), respectively absolute returns of continuously compounded rates (for annualised spot rates) and multiplying from left and right with the diagonal matrix Dₜ given by

$${D}_{ii , t} = \{ \begin{matrix}{U}_{i , t - 1} & if {U}_{i} \text{is an FX-rate or equity index,} \\ 1 + {U}_{i , t - 1} & if {U}_{i} \text{is an annualised spot rate.}\end{matrix}$$

This corresponds to a second order expansion under a Gaussian assumption (‘discrete time Itô's formula’).

FX-rates and equity indices are modelled as drift free stochastic equations of the form Uₜ=Uₜ₋₁+σₜ·εₜ. Here σₜ is a dispersion vector, i.e. a row of a ‘square root’ of the covariance matrix, and ‘•’ denotes the euclidean scalar product.

In the case of interest rates, our stochastic modelling applies to discount rates B(t,T). The dispersion vector σ_{B}(t,T) is constructed via transformation from annualised spot rates. If the time to maturity T−t does not coincide with a benchmark time to maturity, linear interpolation is applied to the relative returns (B(t+1,T)−B(t,T))/B(t,T), see (33).

Annualised spot rates are calculated deterministically from discount rates. They are used as an intermediary domain in the computation of σ_{B}(t,T) and for the formulation of user scenarios. Additional drift terms arising from drift or spread scenarios for annualised rates are incorporated in the equation for discount rates by applying second order expansion.

The stochastic process defined by the multivariate equation for the underlyings is conditioned to satisfy drift and spread scenarios. We have shown that the conditioning leads to a well defined transformation of the drift term.

Like drift and spread scenarios, volatility and correlation scenarios are applied pathwise and step by step. For correlation scenarios we use elementary geometric considerations to recompute the correlations with all underlyings and to preserve the positivity of the covariance matrix in this way.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

What is claimed in the present invention is

1. A method for determining a portfolio comprising the steps of:
(a) inputting past portions of one or more time series of one or more underlyings; item inputting one or more views about the future of said one or more time series; and
(b) determining one or more future paths of said one or more time series from said past portions and said views.

2. A method for determining a portfolio as in claim 1 wherein said determining one or more future paths of said one or more time series comprises the steps of:
(a) defining at least one model; and
(b) generating said one or more future paths with said at least one model.

3. A method for determining a portfolio as in claim 2 wherein said defining at least one model step comprises the steps of:
(a) defining at least one variance model; and
(b) defining at least one covariance model.

4. A method for determining a portfolio as in claim 2 wherein said determining one or more future paths step further comprises the steps of:
(a) weighting said future paths generated from said at least one model with said one or more views.

5. A method for determining a portfolio as in claim 1 wherein said one or more views comprise at least one univariate view.

6. A method for determining a portfolio as in claim 5 wherein said at least one univariate view is a level of said one or more time series at a future time.

7. A method for determining a portfolio as in claim 1 wherein said one or more views comprise at least one multivariate view.

8. A method for determining a portfolio as in claim 7 wherein said at least one multivariate view is a coupling among two or more said time series.

9. A method for determining a portfolio as in claim 1 wherein said one or more views comprise at least one static scenario.

10. A method for determining a portfolio as in claim 1 wherein said one or more views comprises at least one dynamic scenario.

11. A method for determining a portfolio as in claim 10 wherein said at least one dynamic scenario comprises at least one volatility scenario.

12. A method for determining a portfolio as in claim 11 wherein said at least one dynamic scenario comprises at least one volatility scenario.

13. A method for determining a portfolio as in claim 11 wherein said at least one dynamic scenario comprises at least one correlation scenario.

14. A method for determining a portfolio as in claim 11 wherein said at least one dynamic scenario comprises at least one drift scenario.

15. A method for determining a portfolio as in claim 1 further comprising the steps of:
(a) determining at least one portfolio that is optimal from said one or more future paths of said one or more time series of said one or more underlyings.

16. A method for determining a portfolio as in claim 15 wherein the portfolio comprises one or more assets.

17. A method for determining a portfolio as in claim 16 further comprising the step of:
(a) computing one or more returns of said one or more assets from said one or more time series of said one or more underlyings.

18. A method for determining a portfolio as in claim 17 further comprising the step of:
(a) determining one or more means corresponding to said one or more returns of said one or more assets; and
(b) determining one or more covariances corresponding to said one or more returns of said one or more assets.

19. A method for determining a portfolio as in claim 18 further comprising the step of:
(a) estimating a return expectation of one or more portfolios in a portfolio space from said one or more means of said one or more assets and from said one or more covariances of said one or more assets.

20. A method for determining a portfolio as in claim 19 further comprising the steps of:
(a) searching over said portfolio space for at least one of said portfolios having an optimal value of said return expectation.

21. A method for determining a portfolio as in claim 18 wherein said one or more means and said one or more variances of said one or more assets are computed over a re-allocation horizon.

22. A method for determining a portfolio as in claim 21 wherein said re-allocation horizon is ten business days.

23. A method for determining a portfolio as in claim 20 wherein said mean of said one or more assets over a re-allocation horizon is defined as a mean expectation for a unit holding in said asset at said re-allocation horizon.

24. A method for determining a portfolio as in claim 16 wherein said determining the port-folio step comprises the steps of:
(a) computing a current portfolio;
(b) selecting at least one of said assets in said current portfolio to change; and
(c) changing a quantity of said at least one selected asset of said current portfolio to create at least one re-allocated portfolio.

25. A method for determining a portfolio as in claim 24 wherein said determining the port-folio step further comprises the step of:
(a) assigning said re-allocated portfolio to said current portfolio; and
(b) repeating said changing quantities of said at least one selected asset step and said assigning said re-allocated portfolio step.

26. A method for determining a portfolio as in claim 24 wherein said determining the port-folio step further comprises the steps of:
(a) assigning said re-allocated portfolio to said current portfolio; and
(b) repeating said changing quantities of said at least one selected asset step.

27. A method for determining a portfolio as in claim 24 wherein said determining the port-folio step further comprises the step of:
(a) inputting at least one transaction costs for at least one of said assets.

28. A method for determining a portfolio as in claim 27 wherein said transaction costs are considered by said selecting at least one of said assets step.

29. A method for determining a portfolio as in claim 16 wherein the portfolio comprises at least one strategy.

30. A method for determining a portfolio as in claim 29 wherein said at least one strategy comprises one or more rules for buying or selling said one or more assets.

31. A method for determining a portfolio as in claim 30 wherein said at least one strategy comprises at least one trading model.

32. Computer executable software code stored on a computer readable medium, the code for determining a portfolio, the code comprising:
(a) code to input past portions of one or more time series of one or more underlyings;
(b) code to input one or more views about the future of said one or more time series; and
(c) code to determine one or more future paths of said one or more time series from said past portions and said views.

33. Computer executable software code stored on a computer readable medium, the code for determining a portfolio as in claim 32, the code further comprising:
(a) code to define at least one model; and
(b) code to generate said one or more future paths with said at least one model.

34. Computer executable software code stored on a computer readable medium, the code for determining a portfolio as in claim 33, the code further comprising:
(a) code to weight said future paths generated from said at least one model with said one or more views.

35. Computer executable software code stored on a computer readable medium, the code for determining a portfolio as in claim 34, the code further comprising:
(a) code to determine at least one portfolio that is optimal from said one or more future paths of said one or more time series of said one or more underlyings.

36. A programmed computer for determining a portfolio, comprising at least one memory having at least one region storing computer executable program code and at least one processor for executing the program code stored in said memory, wherein the program code includes:
(a) code to input past portions of one or more time series of one or more underlyings;
(b) code to input one or more views about the future of said one or more time series; and
(c) code to determine one or more future paths of said one or more time series from said past portions and said views.

37. A programmed computer for determining a portfolio, comprising at least one memory having at least one region storing computer executable program code and at least one processor for executing the program code stored in said memory as in claim 36, wherein the program code further includes:
(a) code to define at least one model; and
(b) code to generate said one or more future paths with said at least one model.

38. A programmed computer for determining a portfolio, comprising at least one memory having at least one region storing computer executable program code and at least one processor for executing the program code stored in said memory as in claim 37, wherein the program code further includes:
(a) code to weight said future paths generated from said at least one model with said one or more views.

39. A programmed computer for determining a portfolio, comprising at least one memory having at least one region storing computer executable program code and at least one processor for executing the program code stored in said memory as in claim 36, wherein the program code further includes:
(a) code to determine at least one portfolio that is optimal from said one or more future paths of said one or more time series of said one or more underlyings.

40. A method for interacting with a computer to determine a portfolio comprising the steps of:
(a) executing an application comprising at least one input command to select one or more assets for the portfolio and to define one or more forecasts, and at least one output command to display one or more results;
(b) issuing said at least one input command to cause the application to display at least one configuration window having a plurality of input controls;
(c) manipulating said input controls in said configuration window to select one or more assets for the portfolio and to define one or more forecasts; and
(d) issuing said at least one output command to cause the application to produce and display one or more results.

41. A method for interacting with a computer to determine a portfolio as in claim 40 wherein said one or more results comprise one or more simulation results.

42. A method for interacting with a computer to determine a portfolio as in claim 41 wherein said one or more simulation results comprise one or more members of the group consisting of expected return, standard deviation and correlation.

43. A method for interacting with a computer to determine a portfolio as in claim 40 wherein said one or more results comprise one or more allocation results.

44. A method for interacting with a computer to determine a portfolio as in claim 43 wherein said one or more allocation results comprise one or more members of the groups consisting of value at risk, efficient frontier, and portfolio allocation.

45. A method for interacting with a computer to determine a portfolio as in claim 40 wherein said issuing said at least one output command further causes the application to display a progress window.

46. A method for interacting with a computer to determine a portfolio as in claim 40 wherein said at least one configuration window comprises at least one attributes window having at least one attribute field and at least one attribute control.

47. A method for interacting with a computer to determine a portfolio as in claim 46 further comprising the step of
(a) manipulating said at least one attribute control to specify at least one value for said at least one attribute field.

48. A method for interacting with a computer to determine a portfolio as in claim 46 wherein said at least one attribute field comprises one or more members of the group consisting of a profit/loss currency, a finance currency, a current date, a reallocation date, a maximum investment for said one or more assets, a value at risk limit, a confidence level, a mode and a distribution.

49. A method for interacting with a computer to determine a portfolio as in claim 40 wherein said at least one configuration window comprises at least one assets window having at least one asset field and at least one asset control.

50. A method for interacting with a computer to determine a portfolio as in claim 49 further comprising the step of:
(a) manipulating said at least one asset control to specify at least one value for said at least one asset field.

51. A method for interacting with a computer to determine a portfolio as in claim 49 wherein said at least one asset field comprises one or more members of the group consisting of a name, a type, a Reuters code, a currency, a yield curve, a principal, a transaction cost, an allocation constraint, a multi-asset constraint and a visualization option.

52. A method for interacting with a computer to determine a portfolio as in claim 51 wherein said transaction cost has one or more types.

53. A method for interacting with a computer to determine a portfolio as in claim 52 wherein said one or more transaction cost types comprise a member of the group consisting of no transaction cost, percentage of investment, percentage of principal and a fixed amount.

54. A method for interacting with a computer to determine a portfolio as in claim 40 wherein said at least are configurator window comprises at least one scenario window having at least one of said forecasts and at least one scenario control.

55. A method for interacting with a computer to determine a portfolio as in claim 54 further comprising the step of:
(a) manipulating said at least one scenario control to specify at least one value for said at least one forecast.

56. A method for interacting with a computer to determine a portfolio as in claim 40 wherein said one or more forecasts comprise one or more views about one or more underlyings.

57. A method for interacting with a computer to determine a portfolio as in claim 56 wherein said one or more underlyings comprise one or more members of the group consisting of a currency exchange rate, a yield curve and an equity index.

58. A method for interacting with a computer to determine a portfolio as in claim 56 wherein said one or more views comprise one or more member of the group consisting of a level scenario, a volatility scenario, a volatility model, a correlation scenario and a correlation model.

59. A method for interacting with a computer to determine a portfolio as in claim 56 wherein said one or more views comprise a horizon date.

60. A method for interacting with a computer to determine a portfolio as in claim 40 wherein said issuing said at least one output command step causes the application to display at least one job including a plurality of job controls.

61. A method for interacting with a computer to determine a portfolio as in claim 60 further comprising the step of:
(a) manipulating said plurality of job controls to display one or more results pages.

62. A method for interacting with a computer to determine a portfolio as in claim 61 wherein said one or more results comprise one or more simulation result pages.

63. A method for interacting with a computer to determine a portfolio as in claim 61 wherein said one or more result pages comprise one or more allocation result pages.

64. A method for interacting with a computer to determine a portfolio as in claim 40 wherein said one or more results comprise one or more simulation results.

65. A method for interacting with a computer to determine a portfolio as in claim 64 wherein said one or more simulation results comprise one or more members of the group consisting of dated level, current level, arbitrage premium, unit principal, unbiased Sharpe ratio, Sharpe ratio, expected return and standard deviation.

66. A method for interacting with a computer to determine a portfolio as in claim 64 wherein said one or more simulation results comprise a cone of a plurality of simulations of said one or more assets.

67. A method for interacting with a computer to determine a portfolio as in claim 64 wherein said simulation results comprise a cone of a plurality of simulations of said underlyings.

68. A method for interacting with a computer to determine a portfolio as in claim 64 wherein said one or more simulation results comprise one or more correlations among one or more pairs of said assets.

69. A method for interacting with a computer to determine a portfolio as in claim 40 wherein said one or more results comprise one or more allocation results.

70. A method for interacting with a computer to determine a portfolio as in claim 69 wherein said one or more allocation results comprise one or more value at risk measures.

71. A method for interacting with a computer to determine a portfolio as in claim 70 wherein said one or more value at risk measures are displayed as one or more group representations.

72. A method for interacting with a computer to determine a portfolio as in claim 70 where said one or more value at risk measures have corresponding one or more holding periods.

73. A method for interacting with a computer to determine a portfolio as in claim 72 wherein said holding period is a reallocation date.

74. A method for interacting with a computer to determine a portfolio as in claim 72 wherein said holding period is one day.

75. A method for interacting with a computer to determine a portfolio as in claim 69 wherein said one or more allocation results comprise at least one efficient frontier.

76. A method for interacting with a computer to determine a portfolio as in claim 75 wherein said at least one efficient frontier comprises at least one plot of one or more points representing one or more strategies.

77. A method for interacting with a computer to determine a portfolio as in claim 76 further comprising the step of:
(a) clicking on at least one said points to view data on said corresponding strategy.

78. A method for interacting with a computer to determine a portfolio as in claim 77 wherein said strategy data comprise data on said assets.

79. A method for interacting with a computer to determine a portfolio as in claim 78 wherein said asset data comprises one or more members of the group consisting of last observed price, arbitrate premium, minimum investment principal, actual investment current, proposed investment amount, transaction costs, net new investment and new position change.

80. A method for interacting with a computer to determine a portfolio as in claim 40 wherein the at least one portfolio comprises an invested amount for each of said one or more selected assets.
